(19) United States
(12) Patent Application Publication
(10) Pub. No.: US 2026/0352283 A1
(43) Pub. Date: Nov. 5, 2026

(54) UNIFIED CHANNEL STATE INFORMATION CODEBOOK

(71) Applicant: Lenovo (Singapore) Pte. Limited, Singapore (SG)

(72) Inventors: Ahmed Hindy, Aurora, IL (US); Vijay Nangia, Woodridge, IL (US)

(73) Assignee: Lenovo (Singapore) Pte. Limited, Singapore (SG)

(21) Appl. No.: 19/109,820

(22) PCT Filed: Sep. 6, 2023
(86) PCT No.: PCT/IB2023/058790

§ 371 Date: Mar. 7, 2025

Related U.S. Application Data
(60) Provisional application No. 63/406,685, filed on Sep. 14, 2022.

(51) Int. Cl. H04B 7/06

(52) U.S. Cl. CPC H04B 7/0626; H04B 7/0632; H04B 7/0639

(57) ABSTRACT

Various aspects of the present disclosure relate to an apparatus, such as a user equipment (UE), that receives a first signaling from a base station as a channel state information (CSI) reporting setting. The CSI reporting setting indicates a channel measurement resource (CMR) for at least two CSI-reference signal (RS) segments corresponding to multiple precoder matrix indicator (PMI) layers associated with one or more PMI layer groups. The UE transmits a second signaling to the base station as a CSI report in one of two CSI report modes. The CSI report includes an indication of a number of the one or more PMI layer groups and a PMI corresponding to the multiple PMI layers, where the CSI report mode is based on the number of the one or more PMI layer groups.

### RELATED APPLICATION

This application claims priority to U.S. Provisional Application Ser. No. 63/406,685 filed Sep. 14, 2022 entitled “Unified Channel State Information Codebook,” the disclosure of which is incorporated by reference herein in its entirety.

### TECHNICAL FIELD

The present disclosure relates to wireless communications, and more specifically to channel state information (CSI).

### BACKGROUND

A wireless communications system may include one or multiple network communication devices, such as base stations, which may be otherwise known as an eNodeB (eNB), a next-generation NodeB (gNB), or other suitable terminology. Each of the network communication devices, such as a base station, may support wireless communications for one or multiple user communication devices, which may be otherwise known as user equipment (UE), or other suitable terminology. The wireless communications system may support wireless communications with one or multiple user communication devices by utilizing resources of the wireless communications system, such as time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

In a wireless communications system, multiple panels, transmission reception points (TRPs), and/or remote radio heads (RRHs) are nodes within a cell that may communicate simultaneously with one UE to enhance coverage, throughput, and reliability. The multiple panels, TRPs, and/or RRHs may not be co-located (i.e., are placed in separate, remote locations). Communicating with the same UE via multiple nodes comes at the expense of excessive control signaling between the network devices and the UE, so as to communicate the best transmission configuration, such as whether to support multi-point transmission, and if so, which panel would operate simultaneously, in addition to a possibly super-linear increase in the amount of CSI feedback reported from the UE to the network, since a distinct codebook may be needed for each point.

### SUMMARY

The present disclosure relates to methods, apparatuses, and systems that support unified CSI codebook, such as a unified CSI codebook design for both coherent and non-coherent joint transmission. By utilizing the described techniques, the efficiency of CSI feedback overhead is improved by allocating different quantization resolution to precoders corresponding to two subsets of TRPs, based on their channel gains to the UE, and/or by allocating a different number of non-zero coefficients corresponding to the two subsets of TRPs, based on their channel gains to the UE.

Aspects of the disclosure are directed to a unified CSI codebook design that supports both coherent joint transmission (CJT) and non-coherent joint transmission (NCJT) pre-coded transmission in NR. A unified codebook design for physical downlink shared channel (PDSCH) pre-coded transmission across a K-number of TRPs can be implemented that supports both CJT and NCJT up to the K-number of TRPs. For CJT, the up to K-number of TRPs transmit a same set of PDSCH layers, and for NCJT, the K-number of TRPs transmit different sets of PDSCH layers. A CSI feedback overhead reduction approach is applied that provides a concise CSI feedback overhead when toggling between CJT and NCJT modes, to avoid the CSI feedback overhead being parametrized by the largest of the two transmission modes. Further, a fallback approach for both CJT and NCJT modes is supported that enables the network to toggle between CJT and single-point transmission, as well as toggle between NCJT with K>2 TRPs to NCJT with two TRPs, without impacting CSI quality.

In some implementations of the method and apparatuses described herein, a UE receives a first signaling from a base station as a CSI reporting setting. The CSI reporting setting indicates a channel measurement resource (CMR) for at least two CSI-reference signal (CSI-RS) segments corresponding to multiple precoder matrix indicator (PMI) layers associated with one or more PMI layer groups. The UE transmits a second signaling to the base station as a CSI report in one of two CSI report modes. The CSI report includes an indication of a number of the one or more PMI layer groups and a PMI corresponding to the multiple PMI layers, where the CSI report mode is based on the number of the one or more PMI layer groups.

In some implementations of the method and apparatuses described herein, a base station transmits a first signaling to a UE as a CSI reporting setting. The CSI reporting setting indicates a CMR for at least two CSI-RS segments corresponding to multiple PMI layers associated with one or more PMI layer groups. The base station receives a second signaling from the UE as a CSI report in one of two CSI report modes. The CSI report includes an indication of a number of the one or more PMI layer groups and a PMI corresponding to the multiple PMI layers, where the CSI report mode is based on the number of the one or more PMI layer groups.

### BRIEF DESCRIPTION OF THE DRAWINGS

FIG. 1 illustrates an example of a wireless communications system that supports sub-band full duplex operation in accordance with aspects of the present disclosure.

FIG. 2 illustrates an example of multiple panels in a coordination cluster connected to a central unit, as related to unified CSI codebook in accordance with aspects of the present disclosure.

FIG. 3 illustrates examples of block-diagonal matrices, as related to unified CSI codebook in accordance with aspects of the present disclosure.

FIG. 4 illustrates an example implementation of ASN.1 code for triggering more than one CSI report within CSI-ReportConfig reporting setting information element (IE), which supports unified CSI codebook in accordance with aspects of the present disclosure.

FIG. 5 illustrates an example implementation of ASN.1 code for triggering two CSI reports within CodebookConfig codebook configuration IE, which supports unified CSI codebook in accordance with aspects of the present disclosure.

FIGS. 6 and 7 illustrate an example of a block diagram of devices that supports unified CSI codebook in accordance with aspects of the present disclosure.

FIGS. 8 through 11 illustrate flowcharts of methods that support unified CSI codebook in accordance with aspects of the present disclosure.

### DETAILED DESCRIPTION

In a wireless communications system, multiple panels, transmission reception points (TRPs), and/or remote radio heads (RRHs) are nodes within a cell that may communicate simultaneously with one UE to enhance coverage, throughput, and reliability. The multiple panels, TRPs, and/or RRHs may not be co-located (i.e., are placed in separate, remote locations). Communicating with the same UE via multiple nodes comes at the expense of excessive control signaling between the network devices and the UE, so as to communicate the best transmission configuration, such as whether to support multi-point transmission, and if so, which panel would operate simultaneously, in addition to a possibly super-linear increase in the amount of CSI feedback reported from the UE to the network, since a distinct codebook may be needed for each point.

Currently (i.e., Rel. 16 Type-II codebook with high resolution), the number of PMI bits fed back from the UE to a gNB via uplink control information (UCI) can be very large (e.g., greater than 1000 bits at large bandwidth), even for a single-point transmission. Typically, a purpose of multi-panel transmission is to improve the spectral efficiency, as well as the reliability and robustness of the connection in different scenarios, and covers both ideal and nonideal backhaul. To increase the reliability using multi-panel transmission, ultra-reliable low-latency communication (URLLC) under multi-panel transmission was agreed, where a UE can be served by multiple TRPs forming a coordination cluster, and may be connected to a central processing unit.

Generally, joint transmissions from a K-number of panels and/or TRPs may be of form Mode1 or Mode2. For Mode1, each of the K-number of panels and/or TRPs transmit a same sequence of data (e.g., signals corresponding to a same set of PDSCH layers), and a UE combines the signals received from the K-number of panels to realize the power gain. This Mode1 assumes full phase coherence across the K-number of panels and/or TRPs. For Mode2, different panels and/or TRPs of the K-number of panels and/or TRPs transmit different sequences of data (e.g., signals corresponding to at least two sets of PDSCH layers), and the UE combines the signals received from the K-number of panels and/or TRPs to realize the multiplexing gain. This Mode2 can be used in the event of full phase coherence across the K-number of panels and/or TRPs (i.e., for CJT across the K-number of panels and/or TRPs), and can also be applied in the event of non-coherence (i.e., NCJT across the K-number of panels and/or TRPs), under which specific setups of transmission of the PDSCH layers across the K-number of panels and/or TRPs are considered.

Aspects of the disclosure are directed to a unified CSI codebook design that can be applied for both Mode1 and Mode2 of PDSCH transmission across a K-number of TRPs. A unified CSI codebook design supports both CJT and NCJT up to the K-number of TRPs, where CJT up to the K-number of TRPs transmits a same set of PDSCH layers, and NCJT up to the K-number of TRPs transmits different sets of PDSCH layers. Additionally, a CSI feedback overhead reduction approach is applied to enable a concise CSI feedback overhead when toggling between the CJT and NCJT modes, such as to avoid the CSI feedback overhead being parametrized by the largest of the two transmission modes. Further, a fallback approach for both the CJT and NCJT modes is supported that enables the network to toggle between CJT and single-point transmission, as well as toggle between NCJT with K>2 TRPs to NCJT with two TRPs, without impacting CSI quality.

By utilizing the described techniques, the efficiency of CSI feedback overhead is improved by allocating different quantization resolution to precoders corresponding to two subsets of TRPs, based on their channel gains to the UE, and/or by allocating a different number of non-zero coefficients corresponding to the two subsets of TRPs, based on their channel gains to the UE.

Aspects of the present disclosure are described in the context of a wireless communications system. Aspects of the present disclosure are further illustrated and described with reference to device diagrams and flowcharts.

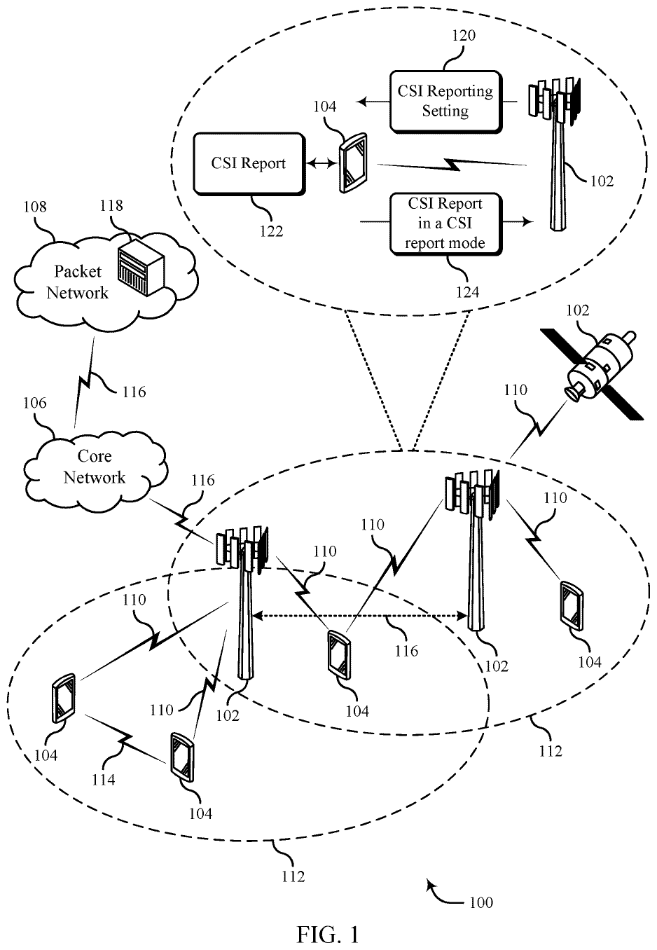

FIG. 1 illustrates an example of a wireless communications system 100 that supports unified CSI codebook in accordance with aspects of the present disclosure. The wireless communications system 100 may include one or more network entities 102, one or more UEs 104, a core network 106, and a packet data network 108. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as an NR network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more network entities 102 may be dispersed throughout a geographic region to form the wireless communications system 100. One or more of the network entities 102 described herein may be or include or may be referred to as a network node, a base station, a network element, a radio access network (RAN), a base transceiver station, an access point, a NodeB, an eNodeB (eNB), a next-generation NodeB (gNB), or other suitable terminology. A network entity 102 and a UE 104 may communicate via a communication link 110, which may be a wireless or wired connection. For example, a network entity 102 and a UE 104 may perform wireless communication (e.g., receive signaling, transmit signaling) over a Uu interface.

A network entity 102 may provide a geographic coverage area 112 for which the network entity 102 may support services (e.g., voice, video, packet data, messaging, broadcast, etc.) for one or more UEs 104 within the geographic coverage area 112. For example, a network entity 102 and a UE 104 may support wireless communication of signals related to services (e.g., voice, video, packet data, messaging, broadcast, etc.) according to one or multiple radio access technologies. In some implementations, a network entity 102 may be moveable, for example, a satellite associated with a non-terrestrial network. In some implementations, different geographic coverage areas 112 associated with the same or different radio access technologies may overlap, but the different geographic coverage areas 112 may be associated with different network entities 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a remote unit, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the network entities 102, other UEs 104, or network equipment (e.g., the core network 106, the packet data network 108, a relay device, an integrated access and backhaul (IAB) node, or another network equipment), as shown in FIG. 1. Additionally, or alternatively, a UE 104 may support communication with other network entities 102 or UEs 104, which may act as relays in the wireless communications system 100.

A UE 104 may also be able to support wireless communication directly with other UEs 104 over a communication link 114. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 114 may be referred to as a sidelink. For example, a UE 104 may support wireless communication directly with another UE 104 over a PC5 interface.

A network entity 102 may support communications with the core network 106, or with another network entity 102, or both. For example, a network entity 102 may interface with the core network 106 through one or more backhaul links 116 (e.g., via an S1, N2, or another network interface). The network entities 102 may communicate with each other over the backhaul links 116 (e.g., via an X2, Xn, or another network interface). In some implementations, the network entities 102 may communicate with each other directly (e.g., between the network entities 102). In some other implementations, the network entities 102 may communicate with each other or indirectly (e.g., via the core network 106). In some implementations, one or more network entities 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

In some implementations, a network entity 102 may be configured in a disaggregated architecture, which may be configured to utilize a protocol stack physically or logically distributed among two or more network entities 102, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 102 may include one or more of a central unit (CU), a distributed unit (DU), a radio unit (RU), a RAN Intelligent Controller (RIC) (e.g., a Near-Real Time RIC (Near-RT RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a transmission reception point (TRP). One or more components of the network entities 102 in a disaggregated RAN architecture may be co-located, or one or more components of the network entities 102 may be located in distributed locations (e.g., separate physical locations). In some implementations, one or more network entities 102 of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3 (L3), a layer 2 (L2)) functionality and signaling (e.g., Radio Resource Control (RRC), service data adaption protocol (SDAP), Packet Data Convergence Protocol (PDCP)). The CU may be connected to one or more DUs or RUs, and the one or more DUs or RUs may host lower protocol layers, such as a layer 1 (L1) (e.g., physical (PHY) layer) or an L2 (e.g., radio link control (RLC) layer, medium access control (MAC) layer) functionality and signaling, and may each be at least partially controlled by the CU.

Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities 102 that are in communication via such communication links.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more network entities 102 associated with the core network 106.

The core network 106 may communicate with the packet data network 108 over one or more backhaul links 116 (e.g., via an S1, N2, or another network interface). The packet data network 108 may include an application server 118. In some implementations, one or more UEs 104 may communicate with the application server 118. A UE 104 may establish a session (e.g., a protocol data unit (PDU) session, or the like) with the core network 106 via a network entity 102. The core network 106 may route traffic (e.g., control information, data, and the like) between the UE 104 and the application server 118 using the established session (e.g., the established PDU session). The PDU session may be an example of a logical connection between the UE 104 and the core network 106 (e.g., one or more network functions of the core network 106).

In the wireless communications system 100, the network entities 102 and the UEs 104 may use resources of the wireless communications system 100, such as time resources (e.g., symbols, slots, subframes, frames, or the like) or frequency resources (e.g., subcarriers, carriers) to perform various operations (e.g., wireless communications). In some implementations, the network entities 102 and the UEs 104 may support different resource structures. For example, the network entities 102 and the UEs 104 may support different frame structures. In some implementations, such as in 4G, the network entities 102 and the UEs 104 may support a single frame structure. In some other implementations, such as in 5G and among other suitable radio access technologies, the network entities 102 and the UEs 104 may support various frame structures (i.e., multiple frame structures). The network entities 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. The first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. Each slot may include a number (e.g., quantity) of symbols (e.g., orthogonal frequency division multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHz), FR3 (7.125 GHz-24.25 GHZ), FR4 (52.6 GHz-114.25 GHZ), FR4a or FR4-1 (52.6 GHz-71 GHz), and FR5 (114.25 GHZ-300 GHz). In some implementations, the network entities 102 and the UEs 104 may perform wireless communications over one or more of the operating frequency bands. In some implementations, FR1 may be used by the network entities 102 and the UEs 104, among other equipment or devices for cellular communications traffic (e.g., control information, data). In some implementations, FR2 may be used by the network entities 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations, one or more of the network entities 102 and the UEs 104 are operable to implement various aspects of unified CSI codebook, as described herein. For instance, a network entity 102 (e.g., a base station) communicates (e.g., transmits) a CSI reporting setting 120 to the UE 104. The CSI reporting setting 120 indicates various information, such as a CMR for at least two CSI-RS segments corresponding to multiple PMI layers associated with one or more PMI layer groups. The UE 104 receives the CSI reporting setting 120 transmitted from the network entity 102, and can generate a CSI report 122. The UE transmits the CSI report 122 to the network entity 102 in one of two CSI report modes 124. The CSI report 122 includes an indication of a number of the one or more PMI layer groups and a PMI corresponding to the multiple PMI layers, where the CSI report mode 124 is based on the number of the one or more PMI layer groups. Accordingly, the network entity 102 receives as the CSI report in the CSI report mode from the UE.

In a wireless communications system, multiple panels, TRPs, and/or RRHs are nodes within a cell that may communicate simultaneously with one UE to enhance coverage, throughput, and reliability. The multiple panels, TRPs, and/or RRHs may not be co-located (i.e., are placed in separate, remote locations). Communicating with the same UE via multiple nodes comes at the expense of excessive control signaling between the network devices and the UE, so as to communicate the best transmission configuration, such as whether to support multi-point transmission, and if so, which panel would operate simultaneously, in addition to a possibly super-linear increase in the amount of CSI feedback reported from the UE to the network, since a distinct codebook may be needed for each point.

Currently (i.e., Rel. 16 Type-II codebook with high resolution), the number of PMI bits fed back from the UE to a gNB via UCI can be very large (e.g., greater than 1000 bits at large bandwidth), even for a single-point transmission. Typically, a purpose of multi-panel transmission is to improve the spectral efficiency, as well as the reliability and robustness of the connection in different scenarios, and covers both ideal and nonideal backhaul.

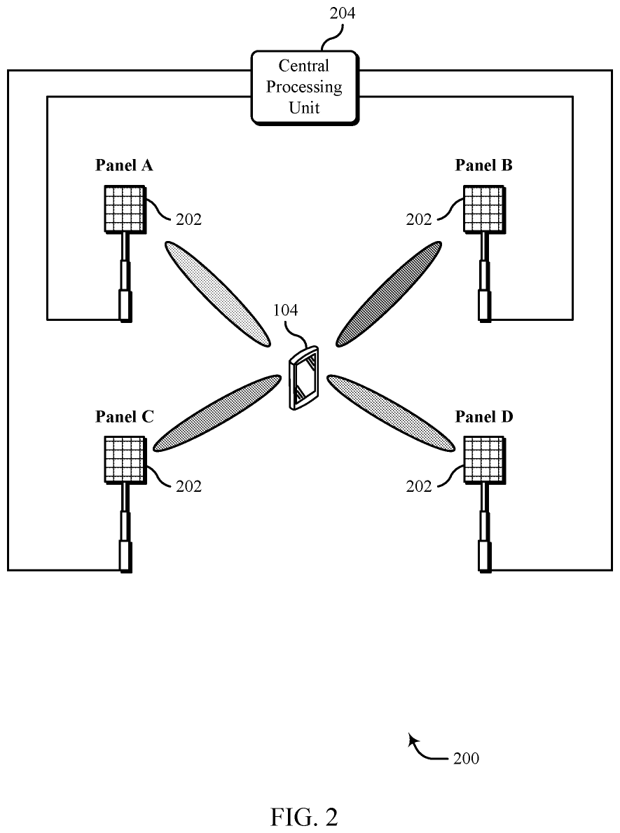

FIG. 2 illustrates an example 200 of multiple panels 202 in a coordination cluster connected to a central processing unit 204, as related to unified CSI codebook in accordance with aspects of the present disclosure. To increase the reliability using multi-panel transmission, URLLC under multi-panel transmission was agreed, where a UE can be served by multiple TRPs forming a coordination cluster, and may be connected to a central processing unit. Generally, joint transmissions from a K-number of panels and/or TRPs may be of form Mode1 or Mode2. For Mode1, each of the K-number of panels and/or TRPs transmit a same sequence of data (e.g., signals corresponding to a same set of PDSCH layers), and a UE combines the signals received from the K-number of panels to realize the power gain. This Mode1 assumes full phase coherence across the K-number of panels and/or TRPs. For Mode2, different panels and/or TRPs of the K-number of panels and/or TRPs transmit different sequences of data (e.g., signals corresponding to at least two sets of PDSCH layers), and the UE combines the signals received from the K-number of panels and/or TRPs to realize the multiplexing gain. This Mode2 can be used in the event of full phase coherence across the K-number of panels and/or TRPs (i.e., for CJT across the K-number of panels and/or TRPs), and can also be applied in the event of non-coherence (i.e., NCJT across the K-number of panels and/or TRPs), under which specific setups of transmission of the PDSCH layers across the K-number of panels and/or TRPs are considered.

As described herein, terms used interchangeably include TRP, panel, set of antennas, set of antenna ports, uniform linear array, cell, node, radio head, communication (e.g., signals/channels) associated with a control resource set (CORESET) pool, and communication associated with a transmission configuration indicator (TCI) state from a transmission configuration comprising at least two TCI states. Further, the codebook type used is arbitrary, and flexibility is allotted for the use of different codebook types (e.g., Type-II Rel. 16 codebook, Type-II Rel. 17 codebook, etc.).

Generally, conventional solutions include Rel.15 Type-I multi-panel codebook for multi-TRP transmission with co-phasing introduced between two panels, or alternatively Rel.15 Type-I single-panel codebook for each TRP of the multiple TRPs. A drawback is that Type-I multi-panel codebook provides low-resolution CSI feedback, which may not suffice to provide good performance for Rel-18 CJT, compared with single-point transmission with high-resolution precoder codebook from the strongest TRP. Further, Rel. 16 Type-II codebook for each TRP of the multiple TRPs has the drawback of Type-II codebook has significantly large CSI feedback overhead corresponding to high-resolution quantization of coefficients due to reporting a per-layer bitmap for each TRP, although each TRP may transmit only a subset of the PDSCH layers.

With reference to NR Rel. 15 Type-II codebook, and assuming that a gNB is equipped with a 2D antenna array with N₁, N₂ antenna ports per polarization placed horizontally and vertically, and communication occurs over N₃ PMI sub-bands. A PMI sub-band includes a set of resource blocks, and each resource block includes a set of subcarriers. In this case, 2N₁N₂ CSI-RS ports are utilized to enable DL channel estimation with high resolution for NR Rel. 15 Type-II codebook. In order to reduce the uplink (UL) feedback overhead, a Discrete Fourier transform (DFT)-based CSI compression of the spatial domain is applied to L dimensions per polarization, where L<N₁N₂. In the sequel, the indices of the 2L dimensions are referred as the spatial domain (SD) basis indices. The magnitude and phase values of the linear combination coefficients for each sub-band are fed back to the gNB as part of the CSI report. The 2N₁N₂×N₃ codebook per layer takes on the form:

W=W₁W₂,

where W₁ is a 2N₁N₂×2L block-diagonal matrix (L<N₁N₂) with two identical diagonal blocks, i.e.,

$${W}_{1} = [ \begin{matrix}B & 0 \\ 0 & B\end{matrix} ] ,$$

and B is an N₁N₂×L matrix with columns drawn from a 2D oversampled DFT matrix, as follows:

$${u}_{m} = [ \begin{matrix}1 & {e}^{j \frac{2 π m}{{O}_{2} {N}_{2}}} & ⋯ & {e}^{j \frac{2 π m ( {N}_{2} - 1 )}{{O}_{2} {N}_{2}}}\end{matrix} ] ,$$

$${v}_{l , m} = {[ \begin{matrix}{u}_{m} & {e}^{j \frac{2 π l}{{O}_{1} {N}_{1}}} {u}_{m} & ⋯ & {e}^{j \frac{2 π l ( {N}_{1} - 1 )}{{O}_{1} {N}_{1}}} {u}_{m}\end{matrix} ]}^{T} ,$$

$$B = [ \begin{matrix}{v}_{{l}_{0} , {m}_{0}} & {v}_{{l}_{1} , {m}_{1}} & ⋯ & {v}_{{l}_{L - 1} , {m}_{L - 1}}\end{matrix} ] ,$$

$${l}_{i} = {O}_{1} {n}_{1}^{( i )} + {q}_{1} , 0 \leq {n}_{1}^{( i )} < {N}_{1} , 0 \leq {q}_{1} < {O}_{1} - 1 ,$$

$${m}_{i} = {O}_{2} {n}_{2}^{( i )} + {q}_{2} , 0 \leq {n}_{2}^{( i )} < {N}_{2} , 0 \leq {q}_{2} < {O}_{2} - 1 ,$$

where the superscript T denotes a matrix transposition operation. Note that O₁, O₂ oversampling factors are assumed for the 2D DFT matrix from which matrix B is drawn. Note that W₁ is common across all layers. W₂ is a 2L×N₃ matrix, where the i^{th} column corresponds to the linear combination coefficients of the 2L beams in the i^{th} sub-band. Only the indices of the L selected columns of B are reported, along with the oversampling index taking on 0102 values. Note that W₂ are independent for different layers.

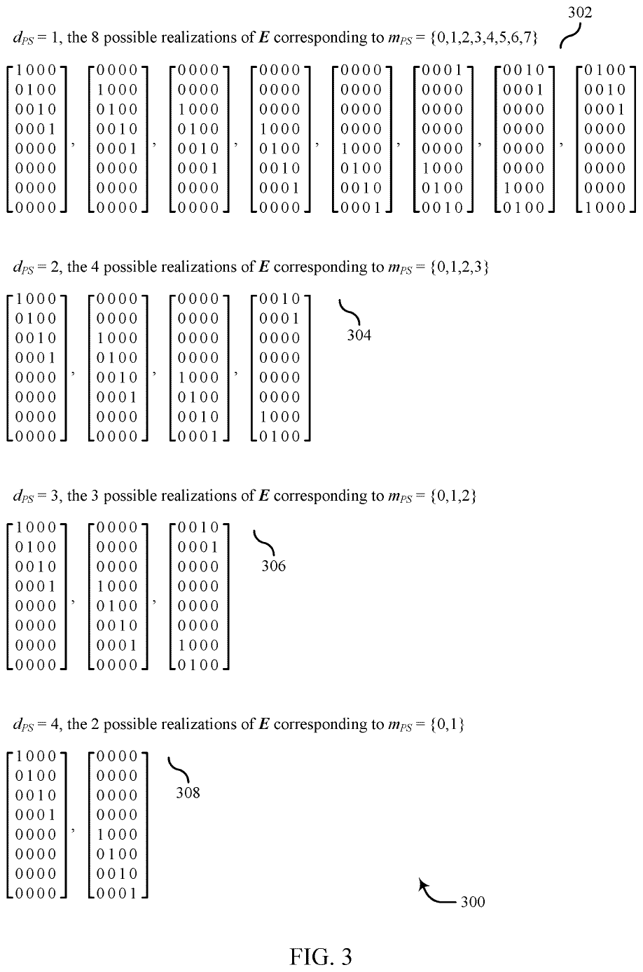

FIG. 3 illustrates examples 300 of block-diagonal matrices, as related to unified CSI codebook in accordance with aspects of the present disclosure. For Type-II Port Selection codebook, only K (where K≤2N₁N₂) beamformed CSI-RS ports are utilized in downlink (DL) transmission, in order to reduce complexity. The K×N₃ codebook matrix per layer takes on the form:

$$W = {W}_{1}^{PS} {W}_{2} .$$

Here, W₂ follow the same structure as the conventional NR Rel. 15 Type-II codebook and are layer specific. The

$$\\ {W}_{1}^{PS}$$

is a K×2L block-diagonal matrix with two identical diagonal blocks, i.e.,

$${W}_{1}^{PS} = [ \begin{matrix}E & 0 \\ 0 & E\end{matrix} ] ,$$

where

$${e}_{i}^{( K )}$$

is a standard unit vector with a 1 at the i^{th} location. Here d_{PS} is an RRC parameter which takes on the values {1, 2, 3, 4} under the condition d_{PS}≤min (K/2, L), whereas m_{PS} takes on the values

$$\{ 0 , … , ⌈ \frac{K}{2 {d}_{PS}} ⌉ - 1 \}$$

and is reported as part of the UL CSI feedback overhead. The W₁ is common across all layers. As shown at 302 in FIG. 3, for K=16, L=4 and d_{PS}=1, the eight (8) possible realizations of E corresponding to m_{PS}={0, 1, . . . , 7}. Further, as shown at 304, when d_{PS}=2, the four (4) possible realizations of E corresponding to m_{PS}={0, 1, 2, 3}. Further, as shown at 306, when d_{PS}=3, the three (3) possible realizations of E corresponding to m_{PS}={0, 1, 2}. Further, as shown at 308, when d_{PS}=4, the two (2) possible realizations of E corresponding to m_{PS}={0, 1}. In summary, m_{PS} parametrizes the location of the first “1” in the first column of E, whereas d_{PS} represents the row shift corresponding to different values of m_{PS}.

The NR Rel. 15 Type-I codebook is the baseline codebook for NR, with a variety of configurations. The most common utility of Rel. 15 Type-I codebook is a special case of NR Rel. 15 Type-II codebook with L=1 for RI=1, 2, where a phase coupling value is reported for each sub-band (i.e., W₂ is 2×N₃, with the first row equal to [1, 1, . . . , 1] and the second row equal to [e^{j2πø}^{₀}, . . . , e^{j2πØ}^{_{N3-1}}]). Under specific configurations, φ₀=φ₁ . . . =φ, i.e., wideband reporting. For RI>2 different beams are used for each pair of layers. Additionally, NR Rel. 15 Type-I codebook can be depicted as a low-resolution version of NR Rel. 15 Type-II codebook with spatial beam selection per layer-pair and phase combining only.

With reference to NR Rel. 16 Type-II codebook, and assuming a gNB is equipped with a two-dimensional (2D) antenna array with N₁, N₂ antenna ports per polarization placed horizontally and vertically, and communication occurs over N₃ PMI sub-bands. A PMI sub-band includes a set of resource blocks, and each resource block includes of a set of subcarriers. In this case, 2N₁N₂N₃ CSI-RS ports are utilized to enable DL channel estimation with high resolution for NR Rel. 16 Type-II codebook. In order to reduce the UL feedback overhead, a DFT-based CSI compression of the spatial domain is applied to L dimensions per polarization, where L<N₁N₂. Similarly, additional compression in the frequency domain is applied, where each beam of the frequency-domain precoding vectors is transformed using an inverse DFT matrix to the delay domain, and the magnitude and phase values of a subset of the delay-domain coefficients are selected and fed back to the gNB as part of the CSI report. The 2N₁N₂×N₃ codebook per layer takes on the form:

$$W = {W}_{1} {\tilde{W}}_{2} {W}_{f}^{H} ,$$

where W₁ is a 2N₁N₂×2L block-diagonal matrix (L<N₁N₂) with two identical diagonal blocks, i.e.,

$${W}_{1} = [ \begin{matrix}B & 0 \\ 0 & B\end{matrix} ] ,$$

and B is an N₁N₂×L matrix with columns drawn from a 2D oversampled DFT matrix, as follows:

$${u}_{m} = [ \begin{matrix}1 & {e}^{j \frac{2 π m}{{O}_{2} {N}_{2}}} & … & {e}^{j \frac{2 π m ( {N}_{2} - 1 )}{{O}_{2} {N}_{2}}} ] ,\end{matrix}$$

$${v}_{l , m} = [ \begin{matrix}{u}_{m} & {e}^{j \frac{2 π l}{{O}_{1} {N}_{1}}} {u}_{m} & … & {{e}^{j \frac{2 π l ( {N}_{1} - 1 )}{{O}_{1} {N}_{1}}} {u}_{m} ]}^{T} ,\end{matrix}$$

$$B = [ \begin{matrix}{v}_{{l}_{0} , {m}_{0}} & {v}_{{l}_{1} , {m}_{1}} & … & {v}_{{l}_{L - 1} , {m}_{L - 1}} ] ,\end{matrix}$$

$${l}_{i} = {O}_{1} {n}_{1}^{( i )} + {q}_{1} , 0 \leq {n}_{1}^{( i )} < {N}_{1} , 0 \leq {q}_{1} < {O}_{1} - 1 ,$$

$${m}_{i} = {O}_{2} {n}_{2}^{( i )} + {q}_{2} , 0 \leq {n}_{2}^{( i )} < {N}_{2} , 0 \leq {q}_{2} < {O}_{2} - 1 ,$$

where the superscript T denotes a matrix transposition operation. Note that O₁, O₂ oversampling factors are assumed for the 2D DFT matrix from which matrix B is drawn. Note that W₁ is common across all layers. The W_{f} is an N₃×M matrix (M<N₃) with columns selected from a critically sampled size-N₃ DFT matrix, as follows:

$${W}_{f} = [ \begin{matrix}{f}_{{k}_{0}} & {f}_{{k}_{1}} & … & {f}_{{k}_{M ′ - 1}} ] ,\end{matrix} 0 \leq {k}_{i} < {N}_{3} - 1 ,$$

$${f}_{k} = [ \begin{matrix}1 & {e}^{- j \frac{2 π k}{{N}_{3}}} & … & {{e}^{- j \frac{2 π k ( {N}_{3} - 1 )}{{N}_{3}}} ]}^{T} .\end{matrix}$$

Only the indices of the L selected columns of B are reported, along with the oversampling index taking on O₁O₂ values. Similarly, for W_{F}, only the indices of the M selected columns out of the predefined size-N₃ DFT matrix are reported. In the sequel the indices of the M dimensions are referred as the selected frequency domain (FD) basis indices. Hence, L, M represent the equivalent spatial and frequency dimensions after compression, respectively. Finally, the 2L×M matrix \tilde{W}₂ represents the linear combination coefficients (LCCs) of the spatial and frequency DFT-basis vectors. Both \tilde{W}₂, W_{f} are selected independent for different layers. Magnitude and phase values of an approximately β fraction of the 2LM available coefficients are reported to the gNB (β<1) as part of the CSI report. Coefficients with zero magnitude are indicated via a per-layer bitmap. Since all coefficients reported within a layer are normalized with respect to the coefficient with the largest magnitude (strongest coefficient), the relative value of that coefficient is set to unity, and no magnitude or phase information is explicitly reported for this coefficient. Only an indication of the index of the strongest coefficient per layer is reported. Hence, for a single-layer transmission, magnitude and phase values of a maximum of [2βLM]−1 coefficients (along with the indices of selected L, M DFT vectors) are reported per layer, leading to significant reduction in CSI report size, compared with reporting 2N₁N₂×N₃−1 coefficients' information.

For Type-II port selection codebook, only K (where K≤2N₁N₂) beamformed CSI-RS ports are utilized in DL transmission, in order to reduce complexity. The K×N₃ codebook matrix per layer takes on the form:

$$W = {W}_{1}^{PS} {\tilde{W}}_{2} {W}_{f}^{H} .$$

Here, \tilde{W}₂ and W₃ follow the same structure as the conventional NR Rel. 16 Type-II Codebook, where both are layer specific. The matrix

$${W}_{1}^{PS}$$

is a K×2L block-diagonal matrix with the same structure as that in the NR Rel. 15 Type-II port selection codebook.

The Rel. 17 Type-II Port Selection codebook follows a similar structure as that of Rel. 15 and Rel. 16 port-selection codebooks, as follows:

$${W}_{l} = {\overline{W}}_{1}^{PS} {\tilde{W}}_{2 , l} {W}_{f , l}^{H} .$$

However, unlike Rel. 15 and Rel. 16 Type-II port-selection codebooks, the port-selection matrix

$${\overline{W}}_{1}^{PS}$$

supports free selection of the K ports, or more precisely the K/2 ports per polarization out of the N₁N₂ CSI-RS ports per polarization, i.e.,

$$⌈ {log}_{2} ( \begin{matrix}{N}_{1} {N}_{2} \\ K / 2\end{matrix} ) ⌉$$

bits are used to identify the K/2 selected ports per polarization, where this selection is common across all layers. Here, \tilde{W}_{2,1} and W_{f,1} follow the same structure as the conventional NR Rel.16 Type-II Codebook, however M is limited to 1, 2 only, with the network configuring a window of size N={2, 4} for M=2. Moreover, the bitmap is reported unless β=1 and the UE reports all the coefficients for a rank up to a value of two.

With reference to codebook reporting, the codebook report is partitioned into two parts based on the priority of information reported. Each part is encoded separately (and part 1 has a possibly higher code rate). The parameters for NR Rel. 16 Type-II codebook include part 1: RI+channel quality indicator (CQI)+Total number of coefficients, and part 2: SD basis indicator+FD basis indicator/layer+Bitmap/layer+Coefficient Amplitude info/layer+Coefficient Phase info/layer+Strongest coefficient indicator/layer. Furthermore, part 2 CSI can be decomposed into sub-parts each with different priority (higher priority information listed first). Such partitioning is needed to allow dynamic reporting size for codebook based on available resources in the uplink phase. Additionally, the Type-II codebook is based on aperiodic CSI reporting, and only reported in physical uplink shared channel (PUSCH) via downlink control information (DCI) triggering (one exception). Type-I codebook can be based on periodic CSI reporting (physical uplink control channel (PUCCH)) or semi-persistent CSI reporting (PUSCH or PUCCH) or aperiodic reporting (PUSCH).

With reference to priority reporting for part 2 CSI, note that multiple (up to N_{Rep}) CSI reports may be transmitted, with priority as shown in Table 1:

TABLE 1

CSI Reports priority ordering
Priority 0:
For CSI reports 1 to N_{Rep}, Group 0 CSI for
CSI reports configured as ‘typeII-r16’ or
‘typeII-PortSelection-r16’; Part 2 wideband
CSI for CSI reports configured otherwise
Priority 1:
Group 1 CSI for CSI report 1, if configured
as ‘typeII-r16’ or ‘typeII-PortSelection-r16’;
Part 2 subband CSI of even subbands for
CSI report 1, if configured otherwise
Priority 2:
Group 2 CSI for CSI report 1, if configured
as ‘typeII-r16’ or ‘typeII-PortSelection-r16’;
Part 2 subband CSI of odd subbands for
CSI report 1, if configured otherwise
Priority 3:
Group 1 CSI for CSI report 2, if configured
as ‘typeII-r16’ or ‘typeII-PortSelection-r16’;
Part 2 subband CSI of even subbands for
CSI report 2, if configured otherwise
Priority 4:
Group 2 CSI for CSI report 2, if configured
as ‘typeII-r16’ or ‘typeII-PortSelection-r16’.
Part 2 subband CSI of odd subbands for
CSI report 2, if configured otherwise
Priority 2N_{Rep} −1:
Group 1 CSI for CSI report N_{Rep}, if configured
as ‘typeII-r16’ or ‘typeII-PortSelection-
r16’; Part 2 subband CSI of even subbands
for CSI report N_{Rep}, if configured otherwise
Priority 2N_{Rep}:
Group 2 CSI for CSI report N_{Rep}, if configured
as ‘typeII-r16’ or ‘typeII-PortSelection-
r16’; Part 2 subband CSI of odd subbands
for CSI report N_{Rep}, if configured otherwise

Note that the priority of the N_{Rep} CSI reports are based on the following: a CSI report corresponding to one CSI reporting configuration for one cell may have higher priority compared with another CSI report corresponding to one other CSI reporting configuration for the same cell; CSI reports intended to one cell may have higher priority compared with other CSI reports intended to another cell; CSI reports may have higher priority based on the CSI report content (e.g., CSI reports carrying L1-reference signal received power (RSRP) information have higher priority); and CSI reports may have higher priority based on their type (e.g., whether the CSI report is aperiodic, semi-persistent or periodic, and whether the report is sent via PUSCH or PUCCH, may impact the priority of the CSI report).

In light of that, CSI reports may be prioritized as follows, where CSI reports with lower IDs have higher priority:

Pri_{iCSI}(y,k,c,s)=2·N_{cells}·Mₛ·y+N_{cells}·Mₛ·k+Mₛ·c+s

where s is CSI reporting configuration index; Mₛ is maximum number of CSI reporting configurations; c is cell index, and N_{cells} is the number of serving cells; k is zero (0) for CSI reports carrying L1-RSRP or L1-signal-to-interference-and-noise ratio (SINR), one (1) otherwise; and y is zero (0) for aperiodic reports, one (1) for semi-persistent reports on PUSCH, two (2) for semi-persistent reports on PUCCH, and three (3) for periodic reports.

With reference to uplink control information (UCI) bit sequence generation, the bitwidth for RI, layer index (L1), CQI, CSI-RS resource index (CRI) of codebookType=typeI-SinglePanel is provided below in Table 2. In Table 2, n_{RI}, v and Kₛ^{CSI-RS} are the number of allowed rank indicator values, the value of the rank and the number of CSI-RS resources in the corresponding resource set, respectively. The values of the rank indicator field are mapped to allowed rank indicator values with increasing order, where ‘0’ is mapped to the smallest allowed rank indicator value.

TABLE 2
RI, LI, CQI, and CRI of Type-I single-panel codebook

| | Bitwidth | | | | |
|---|---|---|---|---|---|
| | 1 antenna | 2 antenna | 4 antenna | >4 antenna ports | |
| Field | port | ports | ports | Rank1~4 | Rank5~8 |
| Rank Indicator | 0 | min(1, ┌log₂ n_{RI}┐) | min(2, ┌log₂ n_{RI}┐) | ┌log₂ n_{RI}┐ | ┌log₂ n_{RI}┐ |
| Layer | 0 | ┌log₂ υ┐ | min (2, ┌log₂ υ┐) | min (2, ┌log₂ υ┐) | min(2,┌log₂ υ┐) |
| Indicator | | | | | |
| Wide-band | 4 | 4 | 4 | 4 | 4 |
| CQI for the | | | | | |
| first transport | | | | | |
| block (TB) | | | | | |
| Wideband CQI | 0 | 0 | 0 | 0 | 4 |
| for the second | | | | | |
| TB | | | | | |
| Subband | 2 | 2 | 2 | 2 | 2 |
| differential | | | | | |
| CQI for the | | | | | |
| first TB | | | | | |
| Subband | 0 | 0 | 0 | 0 | 2 |
| differential | | | | | |
| CQI for the | | | | | |
| second TB | | | | | |
| CRI | $⌈ {log}_{2} ( {K}_{s}^{CSI - RS} ) ⌉$ | $⌈ {log}_{2} ( {K}_{s}^{CSI - RS} ) ⌉$ | $⌈ {log}_{2} ( {K}_{s}^{CSI - RS} ) ⌉$ | $⌈ {log}_{2} ( {K}_{s}^{CSI - RS} ) ⌉$ | $⌈ {log}_{2} ( {K}_{s}^{CSI - RS} ) ⌉$ |

TABLE 3
Mapping order of CSI fields of one CSI report with
wideband PMI and wideband CQI

| CSI report | |
|---|---|
| number | CSI fields |
| CSI report #n | CRI as in Tables 6.3.1.1.2-3/4, if reported |
| | Rank Indicator as in Tables 6.3.1.1.2-3/4, if reported |
| | Layer Indicator as in Tables 6.3.1.1.2-3/4, if reported |
| | Zero padding bits Oₚ, if needed |
| | PMI wideband information fields X₁, |
| | from left to right as in Tables 6.3.1.1.2-1/2, |
| | if reported |
| | PMI wideband information fields X₂, |
| | from left to right as in Tables 6.3.1.1.2-1/2, |
| | or codebook index for 2 antenna ports |
| | according to Clause 5.2.2.2.1 in |
| | [6, TS38.214], if reported |
| | Wideband CQI for the first TB as in |
| | Tables 6.3.1.1.2-3/4, if reported |
| | Wideband CQI for the second TB as |
| | in Tables 6.3.1.1.2-3/4, if reported |

TABLE 4
Mapping order of CSI Part 1 fields of a CSI report,
with sub-band PMI or sub-band CQI

| CSI report | |
|---|---|
| number | CSI fields |
| CSI report #n | CRI as in Tables 6.3.1.1.2-3/4, if reported |
| CSI part 1 | Rank Indicator as in Tables 6.3.1.1.2-3/4/5, if reported |
| | Wideband CQI for the first TB as |
| | in Tables 6.3.1.1.2-3/4/5, if reported |
| | Subband differential CQI for the first |
| | TB with increasing order of subband |
| | number as in Tables 6.3.1.1.2-3/4/5, if reported |
| | Indicator of the number of non-zero |
| | wideband amplitude coefficients M₀ for |
| | layer 0 as in Table 6.3.1.1.2-5, if reported |
| | Indicator of the number of non-zero |
| | wideband amplitude coefficients M₁ for |
| | layer 1 as in Table 6.3.1.1.2-5 (if the rank |
| | according to the reported RI is |
| | equal to one, this field is set to all zeros), |
| | if 2-layer PMI reporting is allowed |
| | according to the rank restriction in |
| | Clauses 5.2.2.2.3 and 5.2.2.2.4 [6, TS |
| | 38.214] and if reported |

Note:
Subbands for given CSI report n indicated by the higher layer parameter csi-ReportingBand are numbered continuously in the increasing order with the lowest subband of csi-ReportingBand as subband 0.

TABLE 5
Mapping order of wideband CSI Part 2 fields of a CSI
report with sub-band PMI or sub-band CQI

| CSI report | |
|---|---|
| number | CSI fields |
| CSI report #n | Wideband CQI for the second TB as in Tables |
| CSI part 2 | 6.3.1.1.2-3/4/5, if present and reported |
| wideband | Layer Indicator as in Tables 6.3.1.1.2-3/4/5, if reported |
| | PMI wideband information fields X₁, from left |
| | to right as in Tables 6.3.1.1.2-1/2, if reported |
| | PMI wideband information fields X₂, from |
| | left to right as in Tables 6.3.1.1.2-1/2, or codebook |
| | index for 2 antenna ports according to Clause 5.2.2.2.1 in |
| | [6, TS38.214], if pmi-FormatIndicator = widebandPMI |
| | and if reported |

TABLE 6
Mapping order of sub-band CSI Part 2 fields of a CSI report with
sub-band PMI or sub-band CQI. Note that sub-bands for a given
CSI report n indicated by the higher layer parameter csi-ReportingBand
are numbered continuously in the increasing order with the lowest
subband of csi-ReportingBand as subband 0.

| | |
|---|---|
| CSI report | Subband differential CQI for the second TB of all |
| #n | even subbands with increasing order of subband |
| Part 2 | number, as in Tables 6.3.1.1.2-3/4/5, if cqi- |
| subband | FormatIndicator = subbandCQI and if reported |
| | PMI subband information fields X₂ of all |
| | even subbands with increasing order of |
| | subband number, from left to right as in |
| | Tables 6.3.1.1.2-1/2, or codebook index |
| | for 2 antenna ports according to Clause |
| | 5.2.2.2.1 in [6, TS38.214] of all even |
| | subbands with increasing order of subband number, if |
| | pmi-FormatIndicator = subbandPMI and if reported |
| | Subband differential CQI for the second |
| | TB of all odd subbands with increasing |
| | order of subband number, as in Tables 6.3.1.1.2-3/4/5, |
| | if cqi-FormatIndicator = subbandCQI and if reported |
| | PMI subband information fields X₂ of all |
| | odd subbands with increasing order of |
| | subband number, from left to right as in |
| | Tables 6.3.1.1.2-1/2, or codebook index |
| | for 2 antenna ports according to Clause |
| | 5.2.2.2.1 in [6, TS38.214] of all odd |
| | subbands with increasing order of subband number, |
| | if pmi-FormatIndicator = subbandPMI and if reported |

TABLE 7
Mapping order of CSI Part 2 fields of a CSI report with ‘typeII-r16’ or ‘typeII-
PortSelection-r16’ codebook

| CSI report | |
|---|---|
| number | CSI fields |
| CSI report #n | PMI fields X₁, from left to right as in Tables 6.3.2.1.2-1A/2A, if reported |
| CSI part 2, | |
| group 0 | |
| CSI report #n | The following PMI fields X₂, from left to right, as in Tables 6.3.2.1.2- |
| CSI part 2, group 1 | $1 A / 2 A : \{ {i}_{2 , 3 , l} : l = 1 , … , υ \} , {i}_{1 , 5} , \{ {i}_{1 , 6 , l} : l = 1 , … , υ \} and ( ⌈ \frac{{K}^{NZ}}{2} ⌉ - υ ) \times 3$ |
| | highest priority bits of |
| | {i_{2,4,l}: l = 1, . . . , υ}, (┌K^{NZ}/2┐ − υ) × 4 highest priority bits of {i_{2,5,l}: l = |
| | 1, . . . , υ} and v * 2LM_{υ} − ┌K^{NZ}/2┐ highest priority bits of{i_{1,7,l}: l = 1, . . . , υ}, |
| | in decreasing order of priority based on function Pri(l, i, f) defined in clause |
| | 5.2.3 of TS38.214, if reported |
| CSI report #n | The following PMI fields X₂, from left to right, as in Tables 6.3.2.1.2-1A/2A: |
| CSI part 2, | ┌K^{NZ}/2┐ × 3 lowest priority bits of {i_{2,4,l}: l = 1, . . . , υ}, ┌K^{NZ}/2┐ × 4 lowest |
| group 2 | priority bits of {i_{2,5,l}: l = 1, . . . , υ} and ┌K^{NZ}/2┐ lowest priority bits of |
| | {i_{1,7,l}: l = 1, . . . , υ}, in decreasing order of priority based on function |
| | Pri(l, i, f ) defined in clause 5.2.3 of TS38.214, if reported |

The CSI report content in UCI, whether on PUCCH or PUSCH, is provided in detail in 3GPP [TS 38.212]. The rank indicator (RI), if reported, has bitwidth of min(└log₂ Nₚₒᵣₜₛ┐, └log₂ n_{RI}┐), where Nₚₒᵣₜₛ, n_{RI} represent the number of antenna ports and the number of allowed rank indicator values, respectively. On the other hand, the CSI-RS resource indicator (CRI) and the synchronization signal block resource indicator (SSBRI) each have bitwidths of

$$⌈ {log}_{2} {K}_{s}^{CSI - RS} ⌉ , ⌈ {log}_{2} {K}_{s}^{SSB} ⌉ ,$$

respectively, where

$${K}_{s}^{CSI - RS}$$

is the number of CSI-RS

$${K}_{s}^{SSB}$$

signal (SS)/physical broadcast channel (PBCH) blocks in the corresponding resource set for reporting ‘ssb-Index-RSRP’. The mapping order of CSI fields of one CSI report with wideband PMI and wideband CQI on PUCCH is shown below in Table 8:

TABLE 8
Mapping order of CSI fields of one CSI report with wideband
PMI and CQI on PUCCH

| CSI report | |
|---|---|
| number | CSI fields |
| CSI | CRI, if reported |
| report #n | Rank Indicator, if reported |
| | Layer Indicator, if reported |
| | Zero padding bits, if needed |
| | PMI wideband information fields, if reported |
| | PMI wideband information, if reported |
| | Wideband CQI for the first Transport Block, if reported |
| | Wideband CQI for the second Transport Block, if reported |

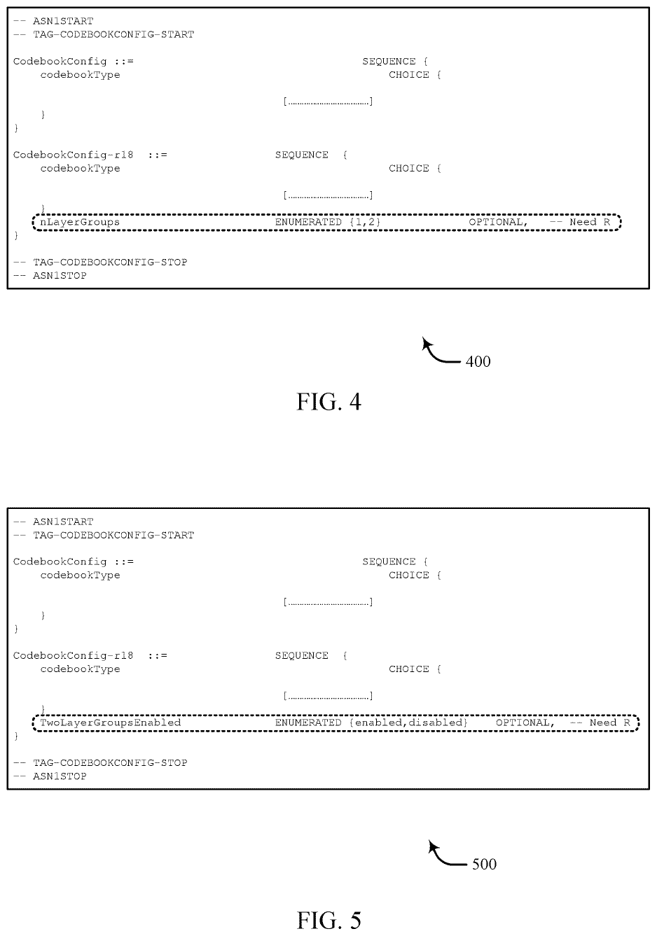

FIG. 4 illustrates an example implementation 400 of ASN.1 code for triggering more than one CSI report within CSI-ReportConfig reporting setting IE, which supports unified CSI codebook in accordance with aspects of the present disclosure. Similarly, FIG. 5 illustrates an example implementation 500 of ASN.1 code for triggering two CSI reports within CodebookConfig codebook configuration IE, which supports unified CSI codebook in accordance with aspects of the present disclosure. Aspects of the present disclosure include different implementations for the indication of a unified CSI codebook for multi-TRP and/or panel transmissions. Further, one or more of the described implementations may be implemented independently, or in combination with one or more of the described implementations. Examples of the ASN.1 code that corresponds to the CSI-ReportConfig reporting setting IE are provided in FIGS. 4 and 5, and the number of CSI reports is triggered within the reporting setting or the codebook configuration, respectively.

With reference to a first implementation for a RRC parameter triggering a unified codebook, a UE configured with a unified CSI codebook for multi-TRP and/or panel transmission is also expected to be configured with a codebook configuration codebookConfig of a CSI reporting setting CSI-ReportConfig that includes a higher-layer parameter which triggers the UE to report multiple layer groups of CSI. In a first example of a RRC parameter, the higher-layer parameter (e.g., nLayerGroups), indicates a maximum number of layer groups to be indicated by a UE, where a maximum number of layer groups of two implies an indication of at most two layer groups. Each layer group of the at most two layer groups includes a mutually exclusive subset of layers from a set of layers inferred from a rank indicator reported by the UE. For instance, nLayerGroups can be set to either one of the following values {1, 2}. In a second example of a RRC parameter for the triggering mode of two layer groups, the higher-layer parameter (e.g., TwoLayerGroupsEnabled), indicates whether a UE is configured with reporting CSI corresponding to a maximum of two layer groups, where each layer group of the at most two layer groups includes a mutually exclusive subset of layers from a set of layers inferred from a rank indicator reported by the UE. For instance, TwoLayerGroupsEnabled can be set to either one of the following values {True, False}, {enabled, disabled} or {1, 0}, etc.

With reference to a second implementation for a UE indication of reporting two layer groups, a UE configured with a unified CSI codebook for multi-TRP and/or panel transmission is also expected to report an indication to the network as part of a CSI report that is fed back over uplink control information (UCI) that indicates whether the reported CSI corresponds to one layer group or to two layer groups. In an example, the UE reports a one-bit indicator in part1 of a CSI report, wherein the indicator value {0} corresponds to a CSI report for CSI that is associated with a single layer group, and the indicator value {1} corresponds to a CSI report for CSI that is associated with two layer groups.

With reference to a third implementation for a unified codebook associated with Rel-18 CJT codebook, a UE configured with a unified CSI codebook for multi-TRP and/or panel transmission is also expected to be configured with a codebook type that is set to a Type-II codebook (e.g., TypeII), and a codebook sub-type that is set to a CJT codebook (e.g., TypeII-CJT-r18), as part of a Rel-18 codebook configuration (e.g., codebookConfig-r18). With reference to a fourth implementation as related to multiple TCI states, a UE configured with a unified CSI codebook for multi-TRP and/or panel transmission is also expected to be configured with a CSI reporting setting CSI-ReportConfig and corresponding CSI-RS resource set(s) for channel measurement include two or more non-zero power (NZP) CSI-RS resources. The two or more NZP CSI-RS resources are associated with different TCI states corresponding to a same demodulation reference signal (DMRS) for PDSCH. In an example, the CSI reporting setting CSI-ReportConfig corresponding to a single CSI-RS resource set for channel measurement includes two or more NZP CSI-RS resources, where different CSI-RS resources are associated with separate layer groups of the two or more layer groups.

With reference to a fifth implementation as related to a unified codebook set only if the number of TRPs are greater than two, a UE is configured with a unified CSI codebook for multi-TRPs and/or panel transmission only if a number of NZP CSI-RS resources associated with CSI-RS resource sets (e.g., one NZP CSI-RS resource set), corresponding to the CSI-reporting setting CSI-ReportConfig is set to a specific value from a set of values. In a first example, the set of values is a single value of {2}, and in a second example, the set of values includes integer values that exceed a value of 2 (e.g., {3, 4}). With reference to a sixth implementation as related to a unified codebook set only if rank is greater than two, a UE is configured with a unified CSI codebook for multi-TRPs and/or panel transmission only if a rank indicator reported by the UE as part of the CSI report exceeds a specific threshold value. In an example, the specific threshold value is {2}.

In aspects of unified CSI codebook, resource allocation and PMI layer grouping are described. With reference to CSI-RS resource allocation corresponding to a K-number of TRPs, each of the multiple TRPs associated with joint transmission to one UE (e.g., via coherent joint transmission) is associated with a distinct or exclusive CSI-RS unit for channel measurement (e.g., K CSI-RS units corresponding to K TRPs). In a first implementation, each CSI-RS unit corresponds to a distinct group of CSI-RS ports within a same NZP CSI-RS resource. In an example, a NZP CSI-RS resource having N CSI-RS ports is decomposed into K groups of N/K exclusive CSI-RS ports, where each CSI-RS port group is associated with a distinct TRP. In another example, a CSI-RS resource of N CSI-RS ports is decomposed into K groups of n₁, n₂, . . . , n_{K} exclusive CSI-RS ports, where n₁+n₂+ . . . +n_{K}=N. The CSI-RS port grouping is based on one or more of a pre-defined rule, and higher-layer signaling (e.g., based on MAC CE or RRC signaling). In another example, each CSI-RS port group corresponds to a different and/or distinct CDM group. In a second implementation, the number of CSI-RS port groups is no larger than the number of CDM groups corresponding to the NZP CSI-RS resource. In a third implementation, each CSI-RS unit corresponds to a distinct NZP CSI-RS resource of a NZP CSI-RS resource set (i.e., a total of K NZP CSI-RS resources within a same NZP CSI-RS resource set are associated with the TCI state(s) corresponding to PDSCH transmission). In this implementation, a NZP CSI-RS resource ID codepoint may correspond to more than one NZP CSI-RS resource.

In aspects as related to CSI-RS unit allocation with PMI layer groups, each of the multiple TRPs associated with joint transmission to one UE (e.g., via coherent joint transmission) is associated with a distinct PMI layer group of at most two layer groups, and each layer group of the at most two layer groups includes a mutually exclusive subset of layers from a set of layers inferred from a rank indicator reported by the UE. In a first implementation for each TRP being associated with a distinct layer group, a unified CSI codebook for multi-TRP and/or panel transmission is associated with two codebook modes. A first codebook mode of the two codebook modes is associated with a single layer group, where a K-number of TRPs corresponding to the K NZP CSI-RS resources are associated with a same set of PMI layers, and a second codebook mode of the two codebook modes is associated with two layer groups. A first subset K′ TRPs of the set of K TRPs, where K′<K, corresponding to K′ NZP CSI-RS resources, is associated with a first layer group of the two layer groups, and a second subset K″ TRPs of the set of K TRPs, where K″<K, corresponding to K″ NZP CSI-RS resources, is associated with a second layer group of the two layer groups, such that K=K′+K″. In an example, each of K′ and K″ cannot exceed a specific threshold value (e.g., 2, i.e., K′≤2 and K″≤2). A CSI report that is associated with K selected and/or indicated CSI-RS units includes K PMI quantities in the CSI report.

In a second implementation for mapping K TRPs to two TRP groups, either UE or network configured, the two TRP groups are mapped to the K TRPs associated with the K NZP CSI-RS resources (e.g., K=4 NZP CSI-RS resources are mapped to two NZP CSI_RS resource groups), such that each CSI-RS resource group is associated with a PMI layer group of the two layer groups. In a first example, the mapping between the K TPRs and the two TRP groups is configured by the network as part of the CSI reporting setting CSI-ReportConfig. In a second example, the mapping between the K TPRs and the two TRP groups is reported by the UE as part of the CSI report. In a third implementation, the number of layers per layer group is upper bounded by a certain value. For the second codebook mode with two layer groups, a number of layers per layer group cannot exceed a threshold value. In a first example, the threshold value is two (i.e., a maximum of two layers per layer group for the second codebook mode). In a second example, the threshold value is a half of the maximum RI that can be reported by a UE, rounded to a nearest integer (e.g., round(), , or . In a fourth implementation for different PMI per layer group, each layer group is associated with a distinct PMI (i.e., two PMI values are reported corresponding to information of the two layer groups). In a fifth implementation for a same PMI for both layer groups, all layer groups are associated with a same PMI (i.e., one PMI values that includes all layer group information is reported).

In aspects as related to codebook structure association with triggering multiple PMI layer groups, the unified CSI codebook for multi-TRP and/or panel transmission is associated with and can support two structures. For a Structure1, a per-TRP or TRP-group SD or FD basis selection, which allows independent FD basis selection across K TRPs or TRP groups. An example formulation (K=number of TRPs or TRP groups):

$$[ \begin{matrix}{W}_{1 , 1} {\tilde{W}}_{2 , 1} {W}_{f , 1}^{H} \\ ⋮ \\ {W}_{1 , K} {\tilde{W}}_{2 , K} {W}_{f , K}^{H}\end{matrix} ]$$

For a Structure2, a per-TRP or TRP group (port-group or resource) SD basis selection and joint or common (across K TRPs) FD basis selection. An example formulation (K=number of TRPs or TRP groups):

$$[ \begin{matrix}{W}_{1 , 1} {\tilde{W}}_{2 , 1} {W}_{f}^{H} \\ ⋮ \\ {W}_{1 , K} {\tilde{W}}_{2 , K} {W}_{f}^{H}\end{matrix} ]$$

Note here that W_{1,k}, \tilde{W}_{2,k}, W_{f,k} correspond to SD basis compression matrix, linear combination coefficient quantization matrix, and FD basis compression matrix for TRP k, respectively, whereas in Structure2, a common FD basis compression matrix W_{f} is applied to all K TRPs. In a first implementation for a unified codebook supported only for codebook Structure1, the unified CSI codebook for multi-TRP and/or panel transmission is supported only if codebook Structure1 is supported, selected, and/or configured. In a second implementation for a unified codebook supported only for codebook Structure2, the unified CSI codebook for multi-TRP and/or panel transmission is supported only if codebook Structure2 is supported, selected, and/or configured.

In aspects as related to bitmap reporting for CSI codebook Mode2, as discussed in the previous section, a unified CSI codebook for multi-TRP and/or panel transmission is associated with two codebook modes. If the second codebook mode with two layer groups is configured, a reporting, indication, and/or configuration of a mapping between a layer of a set of RI layers included in the PMI of the CSI report and a layer group of the two layer groups is needed. Several implementations are provided below, and according to a possible implementation, one or more elements or features from one or more of the described implementations may be combined. In a first implementation for a UE reports an indication of layer group and/or TRP mapping, an indication of the mapping between the layers of the set of RI layers included in the PMI of the CSI report is reported by the UE to the network as part of the CSI report. In an example, the indication is reported in a second part of at least two parts of a CSI report.

In a second implementation for the network configures an indication of layer group and/or TRP mapping, an indication of the mapping between the layers of the set of RI layers included in the PMI of the CSI report is configured by the network and reported to the UE. In a first example, the indication is reported as part of the CSI reporting setting CSI-ReportConfig. In a second example, the mapping is based on a rule that depends on different possible RI values reported by a UE, such as indicated by the example mapping shown in Table 9.

TABLE 9
TRP to Layer mapping for a given RI value

| RI | Mapping |
|---|---|
| 1 | {1}, {—} |
| 2 | {1}, {2} |
| 3 | {1, 3}, {2} |
| 4 | (1, 3}, {2, 4} |

In a third implementation, the indication of the mapping between the layers of the set of RI layers included in the PMI of the CSI report is in a form of a layer-group bitmap. In a first example, the layer-group bitmap is of size RI×K (e.g., RI×K layer-group bitmap matrix), where RI is a reported rank indicator by the UE, and K is a number of TRPs corresponding to K CSI-RS resources. A bit value of one in an (r,k) field of the RI×K layer-group bitmap matrix indicates that a layer r is associated with a transmission from the kₜₕ TRP, and a bit value of zero in an (r′,k) field of the RI×K layer-group bitmap matrix indicates that a layer r′ is not associated with a transmission from the k^{th} TRP. Hence, a bitmap corresponding to the linear combination coefficients of a PMI codebook (e.g., of size 2 LM) associated with a TRP k and rank r′ is not reported if the (r′,k) field of the RI×K layer-group bitmap matrix indicates that a layer r′ is not associated with a transmission from the k^{th} TRP.

In a second example, K layer-group bitmaps of length RI each are indicated, where a bit value of one in an r^{th} field of the k^{th} layer-group bitmap indicates that a layer r is associated with a transmission from the k^{th} TRP, and a bit value of zero in an r′^{th} field of the k^{th} layer-group bitmap indicates that a layer r′ is not associated with a transmission from the k^{th} TRP. Hence, a bitmap corresponding to the linear combination coefficients of a PMI codebook (e.g., of size 2 LM) associated with a TRP k and rank r′ is not reported if a bit value of zero in an r′^{th} field of the k^{th} layer-group bitmap is reported. In a third example, RI layer-group bitmaps of length K each are indicated, where a bit value of one in a k^{th} field of the r^{th} layer-group bitmap indicates that a layer r is associated with a transmission from the k^{th} TRP, and a bit value of zero in a k^{th} field of the r′^{th} layer-group bitmap indicates that a layer r′ is not associated with a transmission from the k^{th} TRP. Hence, a bitmap corresponding to the linear combination coefficients of a PMI codebook (e.g., of size 2LM) associated with a TRP k and rank r′ is not reported if a bit value of zero in a k^{th} field of the r′^{th} layer-group bitmap is reported.

In a fourth implementation for a combinatorial value to indicate layer group and/or TRP mapping, the indication of the mapping between the layers of the set of RI layers included in the PMI of the CSI report is in a form of an encoded value from a codebook of a set of encoded values. Each encoded value from the codebook of the set of encoded values corresponds to a distinct mapping between the layers of the set of RI layers combination of PMI segments and the PMI layer groups.

Other aspects are described as related to an indication of a strongest TRP per PMI layer group. Since TRPs associated with different layer groups are expected to transmit signals corresponding to distinct layers, an indication of a strongest TRP per layer group may be needed. Several implementations are provided, and according to a possible implementation, one or more elements or features from one or more of the described implementations may be combined. In a first implementation, a strongest TRP per layer group has a better L, M, β, and/or quantization resolution. For one layer group of two layer groups, that is associated with two TRPs, a stronger TRP per layer-group is associated with a distinct SD, FD, and/or coefficient transformation or quantization of PMI compared with a weaker TRP per the layer group. In a first example, the stronger TRP is associated with a larger (or equal) number of FD basis indices M compared with a number of FD basis indices M′ of the weaker TRP (i.e., M′≤M). In a second example, the stronger TRP is associated with a larger (or equal) number of SD basis indices L compared with a number of SD basis indices L′ of the weaker TRP (i.e., L′≤L).

In a third example, the stronger TRP is associated with a larger (or equal) fraction of non-zero coefficients β compared with a fraction of non-zero coefficients β′ of the weaker TRP (i.e., β′≤β). In a fourth example, the stronger TRP is associated with a higher quantization resolution of amplitude coefficients, phase coefficients, or both, compared with a quantization resolution of amplitude coefficients, phase coefficients, or both, of the weaker TRP. In a fifth example, a stronger TRP of a layer group is associated with a larger (or equal) reference amplitude coefficient associated with a PMI segment corresponding to the stronger TRP, compared with a reference amplitude coefficient associated with a PMI segment corresponding to the weaker TRP.

In a second implementation for TRPs of a stronger layer group having better L, M, β, and/or quantization resolution, the TRPs associated with the stronger layer group are associated with a distinct SD, FD, and/or coefficient transformation or quantization of PMI compared with TRPs associated with a weaker layer group. In a first example, a TRP associated with the stronger layer group is also associated with a larger (or equal) number of FD basis indices M compared with a number of FD basis indices M′ of a TRP associated with the weaker layer group, i.e., M′≤M). In a second example, a TRP associated with the stronger layer group is also associated with a larger (or equal) number of SD basis indices L compared with a number of SD basis indices L′ of a TRP associated with the weaker layer group, i.e., L′≤L).

In a third example, a TRP associated with the stronger layer group is also associated with a larger (or equal) fraction of non-zero coefficients β compared with a fraction of non-zero coefficients β′ of a TRP associated with the weaker layer group, i.e., β′≤β). In a fourth example, a TRP associated with the stronger layer group is also associated with a higher quantization resolution of amplitude coefficients, phase coefficients, or both, compared with a quantization resolution of amplitude coefficients, phase coefficients, or both, of a TRP associated with the weaker layer group. In a fifth example, a stronger layer group is associated with a larger (or equal) maximum reference amplitude coefficient corresponding to all TRPs of the stronger layer group, compared with a maximum reference amplitude coefficient corresponding to all TRPs of the weaker layer group. In a third implementation, a stronger TRP per layer group has a TRP reference amplitude coefficient value set to a maximum value (e.g., one (1), by default).

Other aspects are described as related to CQI reporting corresponding to two PMI layer groups. Since TRPs associated with a same layer group transmit a same subset of layers, whereas TRPs associated with different layer groups transmit different subsets of layers, a network may only trigger, activate, and/or schedule a subset of TRPs associated with each layer group, or alternatively a subset of TRPs associated with only one layer group, for PDSCH transmission. In the case of only a subset of TRPs is triggered, activated, and/or scheduled for PDSCH transmission, a corresponding CQI value may differ, compared with a scenario in which all TRPs associated with the two layer groups are triggered, activated, and/or scheduled for PDSCH transmission. Hence, an additional CQI may need to be reported to account for different transmission hypotheses associated with different subsets of triggered, activated, and/or scheduled TRPs.

Several implementations are described herein, and according to a possible implementation, one or more elements or features from one or more of the described implementations may be combined. In a first implementation, a UE reports two CQIs in a CSI report. A first CQI value is associated with a transmission hypothesis in which all configured and/or reported TRPs in a CSI report are accounted for, and a second CQI value is associated with a transmission hypothesis in which a stronger TRP corresponding to each layer group is accounted for. In a second implementation, a UE reports two CQIs in a CSI report. A first CQI value is associated with a transmission hypothesis in which all configured and/or reported TRPs of all layer groups in a CSI report are accounted for, and a second CQI value is associated with a transmission hypothesis in which only TRPs corresponding to a stronger layer group are accounted for.

Other aspects are described as related to antenna panels or ports, quasi-collocation, TCI state, and spatial relation. Note that in some implementations, the terms antenna, panel, and antenna panel are used interchangeably. An antenna panel may be a hardware device or component that is used for transmitting and/or receiving radio signals at frequencies lower than 6 GHz (e.g., FR1) or higher than 6 GHz (e.g., FR2) or mmWave. In some implementations, an antenna panel may comprise an array of antenna elements, where each antenna element is connected to hardware such as a phase shifter that allows a control module to apply spatial parameters for transmission and/or reception of signals. The resulting radiation pattern may be called a beam, which may or may not be unimodal and allows the device to amplify signals that are transmitted or received from spatial directions.

In some implementations, an antenna panel may or may not be virtualized as an antenna port in the specifications. An antenna panel may be connected to a baseband processing module through a radio frequency (RF) chain for each of transmission (egress) and reception (ingress) directions. A capability of a device in terms of the number of antenna panels, their duplexing capabilities, beamforming capabilities, and so on, may or may not be transparent to other devices. In some implementations, capability information may be communicated via signaling or, in some implementations, capability information may be provided to devices without a need for signaling. In the case that such information is available to other devices, it can be used for signaling or local decision making.

In some implementations, a device (e.g., a UE or network node) antenna panel may be a physical or logical antenna array having a set of antenna elements or antenna ports that share a common or a significant portion of an RF chain (e.g., in-phase/quadrature (I/Q) modulator, analog to digital (A/D) converter, local oscillator, phase shift network). The device antenna panel or “device panel” may be a logical entity with physical device antennas mapped to the logical entity. The mapping of physical device antennas to the logical entity may be up to device implementation. Communicating (receiving or transmitting) on at least a subset of antenna elements or antenna ports active for radiating energy (also referred to herein as active elements) of an antenna panel requires biasing or powering on of the RF chain which results in current drain or power consumption in the device associated with the antenna panel (including power amplifier and/or low noise amplifier (LNA) power consumption associated with the antenna elements or antenna ports). The phrase “active for radiating energy” as used herein, is not meant to be limited to a transmit function, but also encompasses a receive function. Accordingly, an antenna element that is active for radiating energy may be coupled to a transmitter to transmit radio frequency energy or to a receiver to receive radio frequency energy, either simultaneously or sequentially, or may be coupled to a transceiver in general, for performing its intended functionality. Communicating on the active elements of an antenna panel enables generation of radiation patterns or beams.

In some implementations, depending on the implementation of a particular device, a “device panel” can have at least one of the following functionalities as an operational role of unit of antenna group to control its Tx beam independently, unit of antenna group to control its transmission power independently, or unit of antenna group to control its transmission timing independently. The “device panel” may be transparent to gNB. For certain condition(s), a gNB or network can assume the mapping between a device physical antennas to the logical entity “device panel” may not be changed. For example, the condition may include until the next update or report from the device, or include a duration of time over which the gNB assumes there will be no change to the mapping. A device may report its capability with respect to the “device panel” to the gNB or network. The device capability may include at least the number of “device panels”. In an implementation, the device may support UL transmission from one beam within a panel, and/or with multiple panels, more than one beam (one beam per panel) may be used for UL transmission. In another implementation, more than one beam per panel may be supported or used for UL transmission.

In some of the implementations described, an antenna port is defined such that the channel over which a symbol on the antenna port is conveyed can be inferred from the channel over which another symbol on the same antenna port is conveyed. Two antenna ports are said to be quasi co-located (QCL) if the large-scale properties of the channel over which a symbol on one antenna port is conveyed can be inferred from the channel over which a symbol on the other antenna port is conveyed. The large-scale properties include one or more of delay spread, Doppler spread, Doppler shift, average gain, average delay, and spatial Rx parameters. Two antenna ports may be quasi-located with respect to a subset of the large-scale properties and a different subset of large-scale properties may be indicated by a QCL Type. The QCL Type can indicate which channel properties are the same between the two reference signals (e.g., on the two antenna ports). Thus, the reference signals can be linked to each other with respect to what the UE can assume about their channel statistics or QCL properties. For example, qcl-Type may take one of the following values: ‘QCL-TypeA’: {Doppler shift, Doppler spread, average delay, delay spread}; ‘QCL-TypeB’: {Doppler shift, Doppler spread}; ‘QCL-TypeC’: {Doppler shift, average delay}; ‘QCL-TypeD’: {Spatial Rx parameter}.

Spatial Rx parameters may include one or more of angle of arrival (AoA) dominant AoA, average AoA, angular spread, power angular spectrum (PAS) of AoA, average AoD (angle of departure), PAS of AoD, transmit and/or receive channel correlation, transmit and/or receive beamforming, spatial channel correlation, etc. The QCL-TypeA, QCL-TypeB and QCL-TypeC may be applicable for all carrier frequencies, but the QCL-TypeD may be applicable only in higher carrier frequencies (e.g., mmWave, FR2 and beyond), where essentially the UE may not be able to perform omni-directional transmission (i.e., the UE would need to form beams for directional transmission). A QCL-TypeD between two reference signals A and B, the reference signal A is considered to be spatially co-located with reference signal B and the UE may assume that the reference signals A and B can be received with the same spatial filter (e.g., with the same receive (RX) beamforming weights).

An “antenna port” according to one or more implementations may be a logical port that corresponds to a beam (resulting from beamforming), or may correspond to a physical antenna on a device. In some implementations, a physical antenna may map directly to a single antenna port, in which an antenna port corresponds to an actual physical antenna. Alternately, a set or subset of physical antennas, or an antenna set or antenna array or antenna sub-array, may be mapped to one or more antenna ports after applying complex weights, a cyclic delay, or both to the signal on each physical antenna. The physical antenna set may have antennas from a single module or panel, or from multiple modules or panels. The weights may be fixed as in an antenna virtualization scheme, such as cyclic delay diversity (CDD). The procedure used to derive antenna ports from physical antennas may be specific to a device implementation and transparent to other devices.

In some described implementations, a TCI-state associated with a target transmission can indicate parameters for configuring a quasi-collocation relationship between the target transmission (e.g., target RS of DM-RS ports of the target transmission during a transmission occasion) and a source reference signal(s) (e.g., SSB/CSI-RS/sounding reference signal (SRS)) with respect to quasi co-location type parameter(s) indicated in the corresponding TCI state. The TCI describes which reference signals are used as QCL source, and what QCL properties can be derived from each reference signal. A device can receive a configuration of a plurality of transmission configuration indicator states for a serving cell for transmissions on the serving cell. In some of the implementations described, a TCI state comprises at least one source RS to provide a reference (UE assumption) for determining QCL and/or spatial filter.

In some described implementations, a spatial relation information associated with a target transmission can indicate parameters for configuring a spatial setting between the target transmission and a reference RS (e.g., SSB/CSI-RS/SRS). For example, the device may transmit the target transmission with the same spatial domain filter used for reception of the reference RS (e.g., DL RS such as SSB/CSI-RS). In another example, the device may transmit the target transmission with the same spatial domain transmission filter used for the transmission of the reference RS (e.g., UL RS, such as SRS). A device can receive a configuration of a plurality of spatial relation information configurations for a serving cell for transmissions on the serving cell.

In some described implementations, a UL TCI state is provided if a device is configured with separate DL/UL TCI by RRC signaling. The UL TCI state may include a source reference signal which provides a reference for determining an UL spatial domain transmission filter for the UL transmission (e.g., dynamic-grant or configured-grant based PUSCH, dedicated PUCCH resources) in a component carrier (CC) or across a set of configured CCs or BWPs. Further, in some described implementations, a joint DL/UL TCI state is provided if the device is configured with joint DL/UL TCI by RRC signaling (e.g., configuration of joint TCI or separate DL/UL TCI is based on RRC signaling). The joint DL/UL TCI state refers to at least a common source reference RS used for determining both the DL QCL information and the UL spatial transmission filter. The source RS determined from the indicated joint (or common) TCI state provides QCL Type-D indication (e.g., for device-dedicated physical downlink control channel (PDCCH) and/or PDSCH) and is used to determine an UL spatial transmission filter (e.g., for UE-dedicated PUSCH and/or PUCCH) for a CC or across a set of configured CCs and/or BWPs. In one example, the UL spatial transmission filter is derived from the RS of DL QCL Type D in the joint TCI state. The spatial setting of the UL transmission may be according to the spatial relation with a reference to the source RS configured with qcl-Type set to ‘typeD’ in the joint TCI state.

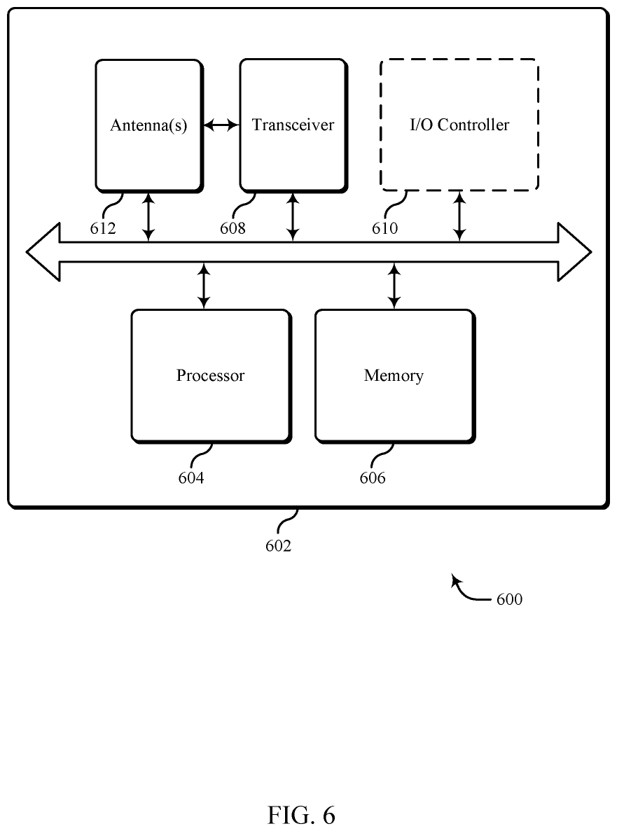

FIG. 6 illustrates an example of a block diagram 600 of a device 602 that supports unified CSI codebook in accordance with aspects of the present disclosure. The device 602 may be an example of a UE 104 as described herein. The device 602 may support wireless communication with one or more network entities 102, UEs 104, or any combination thereof. The device 602 may include components for bi-directional communications including components for transmitting and receiving communications, such as a processor 604, a memory 606, a transceiver 608, and an I/O controller 610. These components may be in electronic communication or otherwise coupled (e.g., operatively, communicatively, functionally, electronically, electrically) via one or more interfaces (e.g., buses).

The processor 604, the memory 606, the transceiver 608, or various combinations thereof or various components thereof may be examples of means for performing various aspects of the present disclosure as described herein. For example, the processor 604, the memory 606, the transceiver 608, or various combinations or components thereof may support a method for performing one or more of the operations described herein.

In some implementations, the processor 604, the memory 606, the transceiver 608, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 604 and the memory 606 coupled with the processor 604 may be configured to perform one or more of the functions described herein (e.g., executing, by the processor 604, instructions stored in the memory 606).

For example, the processor 604 may support wireless communication at the device 602 in accordance with examples as disclosed herein. The processor 604 may be configured as or otherwise support a means for receiving a first signaling from a base station as a CSI reporting setting, the CSI reporting setting indicating a CMR for at least two CSI-RS segments corresponding to multiple PMI layers associated with one or more PMI layer groups; and transmitting a second signaling to the base station as a CSI report in one of two CSI report modes, the CSI report including an indication of a number of the one or more PMI layer groups and a PMI corresponding to the multiple PMI layers, the CSI report mode based at least in part on the number of the one or more PMI layer groups.

Additionally, the processor 604 may be configured as or otherwise support any one or combination of the CSI reporting setting indicates a total number of the one or more PMI layer groups. The CSI report indicates a total number of the one or more PMI layer groups. The one or more PMI layer groups includes a distinct subset of the multiple PMI layers. A first CSI-RS segment of the at least two CSI-RS segments corresponds to a first NZP CSI-RS resource, and a second CSI-RS segment of the at least two CSI-RS segments corresponds to a second NZP CSI-RS resource. A first CSI-RS segment of the at least two CSI-RS segments corresponds to a first subset of a set of CSI-RS ports of a NZP CSI-RS resource, and a second CSI-RS segment of the at least two CSI-RS segments corresponds to a second subset of the set of CSI-RS ports of the NZP CSI-RS resource. The first subset and the second subset of the set of CSI-RS ports corresponds to two CDM groups. The at least two CSI-RS segments are associated with at least two TCI states corresponding to QCL associations with a DMRS for PDSCH. A first CSI report mode of the two CSI report modes is associated with the CSI report comprising one PMI layer group, the one PMI layer group associated with the multiple PMI layers. A second CSI report mode of the two CSI report modes is associated with two PMI layer groups, each of the two PMI layer groups associated with an exclusive subset of the multiple PMI layers. The method further comprising selecting one PMI layer group of the two PMI layer groups. A PMI corresponding to the selected PMI layer group is associated with a different configuration than a configuration of a non-selected PMI layer group corresponding to at least one of a spatial domain basis transformation, a frequency domain basis transformation, a fraction corresponding to a total number of non-zero coefficients, or a quantization resolution. Each of the at least two CSI-RS segments is associated with a distinct one of the two PMI layer groups. An association of each of the at least two CSI-RS segments with the distinct one of the two PMI layer groups is indicated by a layer-group bitmap. The layer-group bitmap indicates whether one of the at least two CSI-RS segments is associated with one PMI layer of the multiple PMI layers. A coefficients bitmap of one PMI layer corresponding to a CSI-RS segment is not reported if the one PMI layer is not associated with the CSI-RS segment. Two CQI values are reported in the CSI report, a first CQI value of the two CQI values is associated with all CSI-RS segments. A second CQI value of the two CQI values is associated with a subset of the CSI-RS segments, the subset of the CSI-RS segments corresponding to a selected CSI-RS segment from each of the two PMI layer groups. A second CQI value of the two CQI values is associated with a subset of the CSI-RS segments, the subset of the CSI-RS segments corresponding to a selected layer group of the two PMI layer groups. A selected CSI-RS segment of a subset of CSI RS segments is associated with one of the two PMI layer groups. A PMI corresponding to the selected CSI-RS segment is associated with a different configuration than a configuration of a non-selected CSI-RS segment of a same PMI layer group corresponding to at least one of a spatial domain basis transformation, a frequency domain basis transformation, a fraction of non-zero coefficients, or a quantization resolution. The selected CSI-RS segment is associated with a maximum reference amplitude value.

Additionally, or alternatively, the device 602, in accordance with examples as disclosed herein, may include a processor and a memory coupled with the processor, the processor configured to: receive a first signaling from a base station as a CSI reporting setting, the CSI reporting setting indicating a CMR for at least two CSI-RS segments corresponding to multiple PMI layers associated with one or more PMI layer groups; and transmit a second signaling to the base station as a CSI report in one of two CSI report modes, the CSI report including an indication of a number of the one or more PMI layer groups and a PMI corresponding to the multiple PMI layers, the CSI report mode based at least in part on the number of the one or more PMI layer groups.

Additionally, the wireless communication at the device 602 may include any one or combination of the CSI reporting setting indicates a total number of the one or more PMI layer groups. The CSI report indicates a total number of the one or more PMI layer groups. Each of the one or more PMI layer groups includes a distinct subset of the multiple PMI layers. A first CSI-RS segment of the at least two CSI-RS segments corresponds to a first NZP CSI-RS resource, and a second CSI-RS segment of the at least two CSI-RS segments corresponds to a second NZP CSI-RS resource. A first CSI-RS segment of the at least two CSI-RS segments corresponds to a first subset of a set of CSI-RS ports of a NZP CSI-RS resource, and a second CSI-RS segment of the at least two CSI-RS segments corresponds to a second subset of the set of CSI-RS ports of the NZP CSI-RS resource. The first subset and the second subset of the set of CSI-RS ports corresponds to two CDM groups. The at least two CSI-RS segments are associated with at least two TCI states corresponding to QCL associations with a DMRS for PDSCH. A first CSI report mode of the two CSI report modes is associated with the CSI report comprising one PMI layer group, the one PMI layer group associated with the multiple PMI layers. A second CSI report mode of the two CSI report modes is associated with two PMI layer groups, each of the two PMI layer groups associated with an exclusive subset of the multiple PMI layers. The processor is configured to select one PMI layer group of the two PMI layer groups. A PMI corresponding to the selected PMI layer group is associated with a different configuration than a configuration of a non-selected PMI layer group corresponding to at least one of a spatial domain basis transformation, a frequency domain basis transformation, a fraction corresponding to a total number of non-zero coefficients, or a quantization resolution. Each of the at least two CSI-RS segments is associated with a distinct one of the two PMI layer groups. An association of each of the at least two CSI-RS segments with the distinct one of the two PMI layer groups is indicated by a layer-group bitmap. The layer-group bitmap indicates whether one of the at least two CSI-RS segments is associated with one PMI layer of the multiple PMI layers. A coefficients bitmap of one PMI layer corresponding to a CSI-RS segment is not reported if the one PMI layer is not associated with the CSI-RS segment. Two CQI values are reported in the CSI report, a first CQI value of the two CQI values is associated with all CSI-RS segments. A second CQI value of the two CQI values is associated with a subset of the CSI-RS segments, the subset of the CSI-RS segments corresponding to a selected CSI-RS segment from each of the two PMI layer groups. A second CQI value of the two CQI values is associated with a subset of the CSI-RS segments, the subset of the CSI-RS segments corresponding to a selected layer group of the two PMI layer groups. A selected CSI-RS segment of a subset of CSI RS segments is associated with one of the two PMI layer groups. A PMI corresponding to the selected CSI-RS segment is associated with a different configuration than a configuration of a non-selected CSI-RS segment of a same PMI layer group corresponding to at least one of a spatial domain basis transformation, a frequency domain basis transformation, a fraction of non-zero coefficients, or a quantization resolution. The selected CSI-RS segment is associated with a maximum reference amplitude value.

The processor 604 of the device 602, such as a UE 104, may support wireless communication in accordance with examples as disclosed herein. The processor 604 includes at least one controller coupled with at least one memory, and is configured to or operable to cause the processor to receive a first signaling as a CSI reporting setting, the CSI reporting setting indicating a CMR for at least two CSI-RS segments corresponding to multiple PMI layers associated with one or more PMI layer groups; and transmit a second signaling as a CSI report in one of two CSI report modes, the CSI report including an indication of a number of the one or more PMI layer groups and a PMI corresponding to the multiple PMI layers, the CSI report mode based at least in part on the number of the one or more PMI layer groups.

The processor 604 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 604 may be configured to operate a memory array using a memory controller. In some other implementations, a memory controller may be integrated into the processor 604. The processor 604 may be configured to execute computer-readable instructions stored in a memory (e.g., the memory 606) to cause the device 602 to perform various functions of the present disclosure.

The memory 606 may include random access memory (RAM) and read-only memory (ROM). The memory 606 may store computer-readable, computer-executable code including instructions that, when executed by the processor 604 cause the device 602 to perform various functions described herein. The code may be stored in a non-transitory computer-readable medium such as system memory or another type of memory. In some implementations, the code may not be directly executable by the processor 604 but may cause a computer (e.g., when compiled and executed) to perform functions described herein. In some implementations, the memory 606 may include, among other things, a basic I/O system (BIOS) which may control basic hardware or software operation such as the interaction with peripheral components or devices.

The I/O controller 610 may manage input and output signals for the device 602. The I/O controller 610 may also manage peripherals not integrated into the device M02. In some implementations, the I/O controller 610 may represent a physical connection or port to an external peripheral. In some implementations, the I/O controller 610 may utilize an operating system such as iOS®, ANDROID®, MS-DOS®, MS-WINDOWS®, OS/2®, UNIX®, LINUX®, or another known operating system. In some implementations, the I/O controller 610 may be implemented as part of a processor, such as the processor 604. In some implementations, a user may interact with the device 602 via the I/O controller 610 or via hardware components controlled by the I/O controller 610.

In some implementations, the device 602 may include a single antenna 612. However, in some other implementations, the device 602 may have more than one antenna 612 (i.e., multiple antennas), including multiple antenna panels or antenna arrays, which may be capable of concurrently transmitting or receiving multiple wireless transmissions. The transceiver 608 may communicate bi-directionally, via the one or more antennas 612, wired, or wireless links as described herein. For example, the transceiver 608 may represent a wireless transceiver and may communicate bi-directionally with another wireless transceiver. The transceiver 608 may also include a modem to modulate the packets, to provide the modulated packets to one or more antennas 612 for transmission, and to demodulate packets received from the one or more antennas 612.

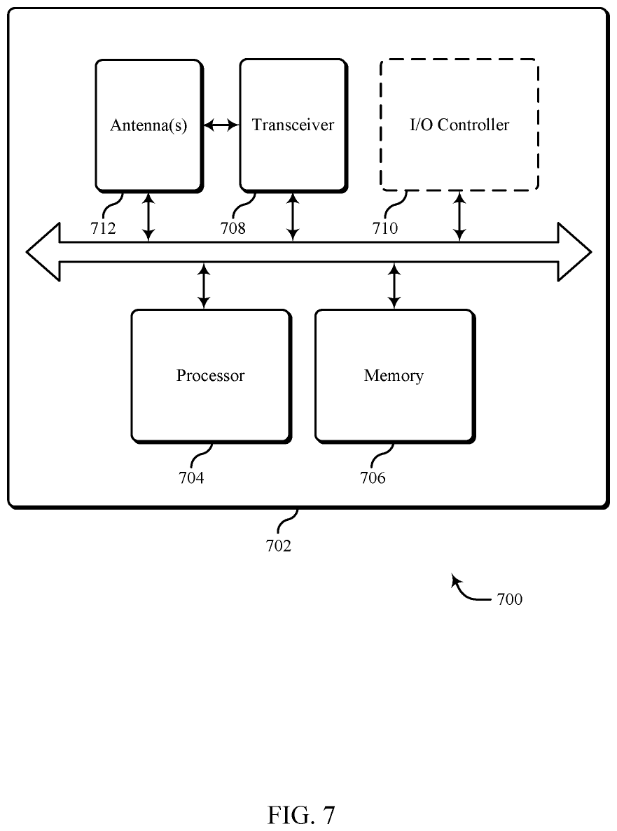

FIG. 7 illustrates an example of a block diagram 700 of a device 702 that supports unified CSI codebook in accordance with aspects of the present disclosure. The device 702 may be an example of a network entity 102, such as a base station as described herein. The device 702 may support wireless communication with one or more network entities 102, UEs 104, or any combination thereof. The device 702 may include components for bi-directional communications including components for transmitting and receiving communications, such as a processor 704, a memory 706, a transceiver 708, and an I/O controller 710. These components may be in electronic communication or otherwise coupled (e.g., operatively, communicatively, functionally, electronically, electrically) via one or more interfaces (e.g., buses).

The processor 704, the memory 706, the transceiver 708, or various combinations thereof or various components thereof may be examples of means for performing various aspects of the present disclosure as described herein. For example, the processor 704, the memory 706, the transceiver 708, or various combinations or components thereof may support a method for performing one or more of the operations described herein.

In some implementations, the processor 704, the memory 706, the transceiver 708, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 704 and the memory 706 coupled with the processor 704 may be configured to perform one or more of the functions described herein (e.g., executing, by the processor 704, instructions stored in the memory 706).

For example, the processor 704 may support wireless communication at the device 702 in accordance with examples as disclosed herein. The processor 704 may be configured as or otherwise support a means for transmitting a first signaling to a UE as a CSI reporting setting, the CSI reporting setting indicates a CMR for at least two CSI-RS segments corresponding to multiple PMI layers associated with one or more PMI layer groups; and receiving a second signaling from the UE as a CSI report in one of two CSI report modes, the CSI report including an indication of a number of the one or more PMI layer groups and a PMI corresponding to the multiple PMI layers, the CSI report mode based at least in part on the number of the one or more PMI layer groups.

Additionally, the processor 704 may be configured as or otherwise support any one or combination of the CSI reporting setting indicates a total number of the one or more PMI layer groups. The CSI report indicates a total number of the one or more PMI layer groups. Each of the one or more PMI layer groups includes a distinct subset of the multiple PMI layers. A first CSI-RS segment of the at least two CSI-RS segments corresponds to a first NZP CSI-RS resource, and a second CSI-RS segment of the at least two CSI-RS segments corresponds to a second NZP CSI-RS resource. A first CSI-RS segment of the at least two CSI-RS segments corresponds to a first subset of a set of CSI-RS ports of a NZP CSI-RS resource, and a second CSI-RS segment of the at least two CSI-RS segments corresponds to a second subset of the set of CSI-RS ports of the NZP CSI-RS resource. The first subset and the second subset of the set of CSI-RS ports corresponds to two CDM groups. The at least two CSI-RS segments are associated with at least two TCI states corresponding to QCL associations with a DMRS for PDSCH. A first CSI report mode of the two CSI report modes is associated with the CSI report comprising one PMI layer group, the one PMI layer group associated with the multiple PMI layers. A second CSI report mode of the two CSI report modes is associated with two PMI layer groups, each of the two PMI layer groups associated with an exclusive subset of the multiple PMI layers. The method further comprising selecting one PMI layer group of the two PMI layer groups. A PMI corresponding to the selected PMI layer group is associated with a different configuration than a configuration of a non-selected PMI layer group corresponding to at least one of a spatial domain basis transformation, a frequency domain basis transformation, a fraction corresponding to a total number of non-zero coefficients, or a quantization resolution. Each of the at least two CSI-RS segments is associated with a distinct one of the two PMI layer groups. An association of each of the at least two CSI-RS segments with the distinct one of the two PMI layer groups is indicated by a layer-group bitmap. The layer-group bitmap indicates whether one of the at least two CSI-RS segments is associated with one PMI layer of the multiple PMI layers. A coefficients bitmap of one PMI layer corresponding to a CSI-RS segment is not reported if the one PMI layer is not associated with the CSI-RS segment. Two CQI values are reported in the CSI report, a first CQI value of the two CQI values is associated with all CSI-RS segments. A second CQI value of the two CQI values is associated with a subset of the CSI-RS segments, the subset of the CSI-RS segments corresponding to a selected CSI-RS segment from each of the two PMI layer groups. A second CQI value of the two CQI values is associated with a subset of the CSI-RS segments, the subset of the CSI-RS segments corresponding to a selected layer group of the two PMI layer groups. A selected CSI-RS segment of a subset of CSI RS segments is associated with one of the two PMI layer groups. A PMI corresponding to the selected CSI-RS segment is associated with a different configuration than a configuration of a non-selected CSI-RS segment of a same PMI layer group corresponding to at least one of a spatial domain basis transformation, a frequency domain basis transformation, a fraction of non-zero coefficients, or a quantization resolution. The selected CSI-RS segment is associated with a maximum reference amplitude value.

Additionally, or alternatively, the device 702, in accordance with examples as disclosed herein, may include a processor and a memory coupled with the processor, the processor configured to: transmit a first signaling to a UE as a CSI reporting setting, the CSI reporting setting indicating a CMR for at least two CSI-RS segments corresponding to multiple PMI layers associated with one or more PMI layer groups; and receive a second signaling from the UE as a CSI report in one of two CSI report modes, the CSI report including an indication of a number of the one or more PMI layer groups and a PMI corresponding to the multiple PMI layers, the CSI report mode based at least in part on the number of the one or more PMI layer groups.

Additionally, the wireless communication at the device 702 may include any one or combination of the CSI reporting setting indicates a total number of the one or more PMI layer groups. The CSI report indicates a total number of the one or more PMI layer groups. Each of the one or more PMI layer groups includes a distinct subset of the multiple PMI layers. A first CSI-RS segment of the at least two CSI-RS segments corresponds to a first NZP CSI-RS resource, and a second CSI-RS segment of the at least two CSI-RS segments corresponds to a second NZP CSI-RS resource. A first CSI-RS segment of the at least two CSI-RS segments corresponds to a first subset of a set of CSI-RS ports of a NZP CSI-RS resource, and a second CSI-RS segment of the at least two CSI-RS segments corresponds to a second subset of the set of CSI-RS ports of the NZP CSI-RS resource. The first subset and the second subset of the set of CSI-RS ports corresponds to two CDM groups. The at least two CSI-RS segments are associated with at least two TCI states corresponding to QCL associations with a DMRS for PDSCH. A first CSI report mode of the two CSI report modes is associated with the CSI report comprising one PMI layer group, the one PMI layer group associated with the multiple PMI layers. A second CSI report mode of the two CSI report modes is associated with two PMI layer groups, each of the two PMI layer groups associated with an exclusive subset of the multiple PMI layers. The processor is configured to select one PMI layer group of the two PMI layer groups. A PMI corresponding to the selected PMI layer group is associated with a different configuration than a configuration of a non-selected PMI layer group corresponding to at least one of a spatial domain basis transformation, a frequency domain basis transformation, a fraction corresponding to a total number of non-zero coefficients, or a quantization resolution. Each of the at least two CSI-RS segments is associated with a distinct one of the two PMI layer groups. An association of each of the at least two CSI-RS segments with the distinct one of the two PMI layer groups is indicated by a layer-group bitmap. The layer-group bitmap indicates whether one of the at least two CSI-RS segments is associated with one PMI layer of the multiple PMI layers. A coefficients bitmap of one PMI layer corresponding to a CSI-RS segment is not reported if the one PMI layer is not associated with the CSI-RS segment. Two CQI values are reported in the CSI report, a first CQI value of the two CQI values is associated with all CSI-RS segments. A second CQI value of the two CQI values is associated with a subset of the CSI-RS segments, the subset of the CSI-RS segments corresponding to a selected CSI-RS segment from each of the two PMI layer groups. A second CQI value of the two CQI values is associated with a subset of the CSI-RS segments, the subset of the CSI-RS segments corresponding to a selected layer group of the two PMI layer groups. A selected CSI-RS segment of a subset of CSI RS segments is associated with one of the two PMI layer groups. A PMI corresponding to the selected CSI-RS segment is associated with a different configuration than a configuration of a non-selected CSI-RS segment of a same PMI layer group corresponding to at least one of a spatial domain basis transformation, a frequency domain basis transformation, a fraction of non-zero coefficients, or a quantization resolution. The selected CSI-RS segment is associated with a maximum reference amplitude value.

The processor 704 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 704 may be configured to operate a memory array using a memory controller. In some other implementations, a memory controller may be integrated into the processor 704. The processor 704 may be configured to execute computer-readable instructions stored in a memory (e.g., the memory 706) to cause the device 702 to perform various functions of the present disclosure.

The memory 706 may include random access memory (RAM) and read-only memory (ROM). The memory 706 may store computer-readable, computer-executable code including instructions that, when executed by the processor 704 cause the device 702 to perform various functions described herein. The code may be stored in a non-transitory computer-readable medium such as system memory or another type of memory. In some implementations, the code may not be directly executable by the processor 704 but may cause a computer (e.g., when compiled and executed) to perform functions described herein. In some implementations, the memory 706 may include, among other things, a basic I/O system (BIOS) which may control basic hardware or software operation such as the interaction with peripheral components or devices.

The I/O controller 710 may manage input and output signals for the device 702. The I/O controller 710 may also manage peripherals not integrated into the device M02. In some implementations, the I/O controller 710 may represent a physical connection or port to an external peripheral. In some implementations, the I/O controller 710 may utilize an operating system such as iOS®, ANDROID®, MS-DOS®, MS-WINDOWS®, OS/2®, UNIX®, LINUX®, or another known operating system. In some implementations, the I/O controller 710 may be implemented as part of a processor, such as the processor 704. In some implementations, a user may interact with the device 702 via the I/O controller 710 or via hardware components controlled by the I/O controller 710.

In some implementations, the device 702 may include a single antenna 712. However, in some other implementations, the device 702 may have more than one antenna 712 (i.e., multiple antennas), including multiple antenna panels or antenna arrays, which may be capable of concurrently transmitting or receiving multiple wireless transmissions. The transceiver 708 may communicate bi-directionally, via the one or more antennas 712, wired, or wireless links as described herein. For example, the transceiver 708 may represent a wireless transceiver and may communicate bi-directionally with another wireless transceiver. The transceiver 708 may also include a modem to modulate the packets, to provide the modulated packets to one or more antennas 712 for transmission, and to demodulate packets received from the one or more antennas 712.

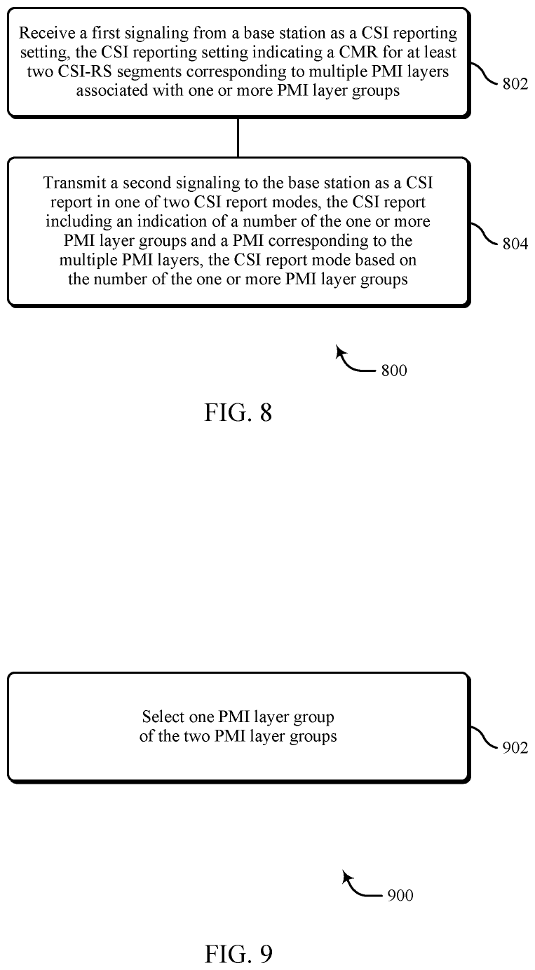

FIG. 8 illustrates a flowchart of a method 800 that supports unified CSI codebook in accordance with aspects of the present disclosure. The operations of the method 800 may be implemented by a device or its components as described herein. For example, the operations of the method 800 may be performed by a UE 104 as described with reference to FIGS. 1 through 7. In some implementations, the device may execute a set of instructions to control the function elements of the device to perform the described functions. Additionally, or alternatively, the device may perform aspects of the described functions using special-purpose hardware.

At 802, the method may include receiving a first signaling from a base station as a CSI reporting setting, the CSI reporting setting indicating a CMR for at least two CSI-RS segments corresponding to multiple PMI layers associated with one or more PMI layer groups. The operations of 802 may be performed in accordance with examples as described herein. In some implementations, aspects of the operations of 802 may be performed by a device as described with reference to FIG. 1.

At 804, the method may include transmitting a second signaling to the base station as a CSI report in one of two CSI report modes, the CSI report including an indication of a number of the one or more PMI layer groups and a PMI corresponding to the multiple PMI layers, the CSI report mode based on the number of the one or more PMI layer groups. The operations of 804 may be performed in accordance with examples as described herein. In some implementations, aspects of the operations of 804 may be performed by a device as described with reference to FIG. 1.

FIG. 9 illustrates a flowchart of a method 900 that supports unified CSI codebook in accordance with aspects of the present disclosure. The operations of the method 900 may be implemented by a device or its components as described herein. For example, the operations of the method 900 may be performed by a UE 104 as described with reference to FIGS. 1 through 7. In some implementations, the device may execute a set of instructions to control the function elements of the device to perform the described functions. Additionally, or alternatively, the device may perform aspects of the described functions using special-purpose hardware.

At 902, the method may include selecting one PMI layer group of the two PMI layer groups. The operations of 902 may be performed in accordance with examples as described herein. In some implementations, aspects of the operations of 902 may be performed by a device as described with reference to FIG. 1.

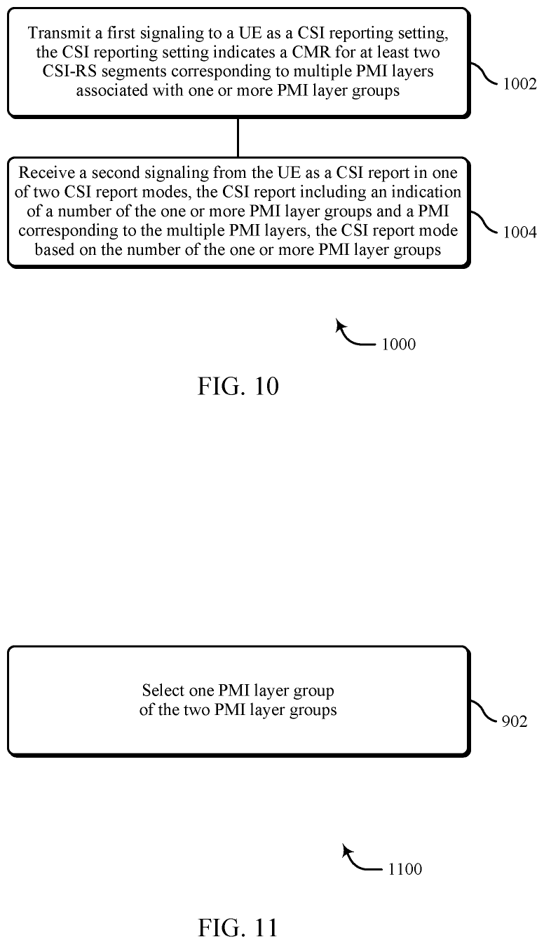

FIG. 10 illustrates a flowchart of a method 1000 that supports unified CSI codebook in accordance with aspects of the present disclosure. The operations of the method 1000 may be implemented by a device or its components as described herein. For example, the operations of the method 1000 may be performed by a network entity 102, such as a base station as described with reference to FIGS. 1 through 7. In some implementations, the device may execute a set of instructions to control the function elements of the device to perform the described functions. Additionally, or alternatively, the device may perform aspects of the described functions using special-purpose hardware.

At 1002, the method may include transmitting a first signaling to a UE as a CSI reporting setting, the CSI reporting setting indicates a CMR for at least two CSI-RS segments corresponding to multiple PMI layers associated with one or more PMI layer groups. The operations of 1002 may be performed in accordance with examples as described herein. In some implementations, aspects of the operations of 1002 may be performed by a device as described with reference to FIG. 1.

At 1004, the method may include receiving a second signaling from the UE as a CSI report in one of two CSI report modes, the CSI report including an indication of a number of the one or more PMI layer groups and a PMI corresponding to the multiple PMI layers, the CSI report mode based on the number of the one or more PMI layer groups. The operations of 1004 may be performed in accordance with examples as described herein. In some implementations, aspects of the operations of 1004 may be performed by a device as described with reference to FIG. 1.

FIG. 11 illustrates a flowchart of a method 1100 that supports unified CSI codebook in accordance with aspects of the present disclosure. The operations of the method 1100 may be implemented by a device or its components as described herein. For example, the operations of the method 1100 may be performed by a network entity 102, such as a base station as described with reference to FIGS. 1 through 7. In some implementations, the device may execute a set of instructions to control the function elements of the device to perform the described functions. Additionally, or alternatively, the device may perform aspects of the described functions using special-purpose hardware.

At 1102, the method may include selecting one PMI layer group of the two PMI layer groups. The operations of 1102 may be performed in accordance with examples as described herein. In some implementations, aspects of the operations of 1102 may be performed by a device as described with reference to FIG. 1.

It should be noted that the methods described herein describe possible implementations, and that the operations and the steps may be rearranged or otherwise modified and that other implementations are possible. Further, aspects from two or more of the methods may be combined.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Similarly, a list of one or more of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

The terms “transmitting,” “receiving,” or “communicating,” when referring to a network entity, may refer to any portion of a network entity (e.g., a base station, a CU, a DU, a RU) of a RAN communicating with another device (e.g., directly or via one or more other network entities).

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A user equipment (UE) for wireless communication, comprising:
at least one memory; and
at least one processor coupled with the at least one memory and configured to cause the UE to:
receive, from a base station (BS), a channel state information (CSI) reporting setting that indicates a channel measurement resource (CMR) for at least two CSI-reference signal (CSI-RS) segments corresponding to multiple precoder matrix indicator (PMI) layers associated with one or more PMI layer groups; and
transmit, to the BS, a CSI report in one of two CSI report modes, the CSI report including an indication of a number of the one or more PMI layer groups and a PMI corresponding to the multiple PMI layers, the CSI report mode based at least in part on the number of the one or more PMI layer groups.

2. The UE of claim 1, wherein the CSI reporting setting indicates a total number of the one or more PMI layer groups.

3. The UE of claim 1, wherein each of the one or more PMI layer groups includes a distinct subset of the multiple PMI layers.

4. The UE of claim 1, wherein a first CSI-RS segment of the at least two CSI-RS segments corresponds to a first non-zero power (NZP) CSI-RS resource, and a second CSI-RS segment of the at least two CSI-RS segments corresponds to a second NZP CSI-RS resource.

5. The UE of claim 1, wherein a first CSI-RS segment of the at least two CSI-RS segments corresponds to a first subset of a set of CSI-RS ports of a non-zero power (NZP) CSI-RS resource, and a second CSI-RS segment of the at least two CSI-RS segments corresponds to a second subset of the set of CSI-RS ports of the NZP CSI-RS resource.

6. The UE of claim 5, wherein the first subset and the second subset of the set of CSI-RS ports corresponds to two code division multiplexing (CDM) groups.

7. The UE of claim 1, wherein the at least two CSI-RS segments are associated with at least two transmission configuration indicator (TCI) states corresponding to quasi co-location (QCL) associations with a demodulation reference signal (DMRS) for a physical downlink shared channel (PDSCH).

8. The UE of claim 1, wherein a first CSI report mode of the two CSI report modes is associated with the CSI report comprising one PMI layer group, the one PMI layer group associated with the multiple PMI layers.

9. The UE of claim 1, wherein a second CSI report mode of the two CSI report modes is associated with two PMI layer groups, each of the two PMI layer groups associated with an exclusive subset of the multiple PMI layers.

10. The UE of claim 9, wherein the at least one processor is configured to cause the UE to select one PMI layer group of the two PMI layer groups.

11. The UE of claim 9, wherein each of the at least two CSI-RS segments is associated with a distinct one of the two PMI layer groups.

12. The UE of claim 11, wherein an association of each of the at least two CSI-RS segments with the distinct one of the two PMI layer groups is indicated by a layer-group bitmap.

13. The UE of claim 12, wherein the layer-group bitmap indicates whether one of the at least two CSI-RS segments is associated with one PMI layer of the multiple PMI layers, and wherein a configured coefficients bitmap of the one PMI layer corresponding to a CSI-RS segment is not reported if the one PMI layer is not associated with the CSI-RS segment.

14. The UE of claim 9, wherein two channel quality indicator (CQI) values are reported in the CSI report, a first CQI value of the two CQI values is associated with all CSI-RS segments.

15. The UE of claim 14, wherein a second CQI value of the two CQI values is associated with a subset of the CSI-RS segments, the subset of the CSI-RS segments corresponding to one of a selected CSI-RS segment from each of the two PMI layer groups, or a selected layer group of the two PMI layer groups.

16. The UE of claim 9, wherein a selected CSI-RS segment of a subset of CSI RS segments is associated with one of the two PMI layer groups.

17. The UE of claim 16, wherein the selected CSI-RS segment is associated with a maximum reference amplitude value.

18. (canceled)

19. A base station (BS) for wireless communication, comprising:
at least one memory; and
at least one processor coupled with the at least one memory and configured to cause the BS to:
transmit, to a user equipment (UE), a channel state information (CSI) reporting setting that indicates a channel measurement resource (CMR) for at least two CSI-reference signal (CSI-RS) segments corresponding to multiple precoder matrix indicator (PMI) layers associated with one or more PMI layer groups; and
receive, from the UE, a CSI report in one of two CSI report modes, the CSI report including an indication of a number of the one or more PMI layer groups and a PMI corresponding to the multiple PMI layers, the CSI report mode based at least in part on the number of the one or more PMI layer groups.

20. A method performed by a user equipment (UE), the method comprising:
receiving, from a base station (BS), a channel state information (CSI) reporting setting that indicates a channel measurement resource (CMR) for at least two CSI-reference signal (CSI-RS) segments corresponding to multiple precoder matrix indicator (PMI) layers associated with one or more PMI layer groups; and
transmitting, to the BS, a CSI report in one of two CSI report modes, the CSI report including an indication of a number of the one or more PMI layer groups and a PMI corresponding to the multiple PMI layers, the CSI report mode based at least in part on the number of the one or more PMI layer groups.

21. A method performed by a base station (BS), the method comprising:
transmitting, to a user equipment (UE), a channel state information (CSI) reporting setting that indicates a channel measurement resource (CMR) for at least two CSI-reference signal (CSI-RS) segments corresponding to multiple precoder matrix indicator (PMI) layers associated with one or more PMI layer groups; and
receiving, from the UE, a CSI report in one of two CSI report modes, the CSI report including an indication of a number of the one or more PMI layer groups and a PMI corresponding to the multiple PMI layers, the CSI report mode based at least in part on the number of the one or more PMI layer groups.
